(19) United States
(12) Patent Application Publication
(10) Pub. No.: US 2026/0288250 A1
(43) Pub. Date: Sep. 24, 2026

(54) Interactive Computing System with Environmental Recognition and Contextual Output

(71) Applicant: APA Holdings, LLC, Maple Grove, MN (US)

(72) Inventors: Paul Michael Goudreau, Edina, MN (US); Andrew Nathaniel Smith, Maple Grove, MN (US); Mark Hatcher, Golden Valley, MN (US); Tyler Lorne Hebig, Lakeville, MN (US); Justin Magoline, Apple Valley, MN (US); Ian Forte, Brooklyn Park, MN (US); Jesse Hemingway, Minneapolis, MN (US); Max Lundeen, Golden Valley, MN (US)

(73) Assignee: APA Holdings, LLC, Maple Grove, MN (US)

(21) Appl. No.: 19/570,608

(22) Filed: Mar. 18, 2026

Related U.S. Application Data
(60) Provisional application No. 63/773,556, filed on Mar. 18, 2025.

(51) Int. Cl. G06F 3/01; A63F 11/00; G06F 3/16; G06T 7/62; G06V 20/20; G06V 20/50; G06V 40/20; G09G 3/00

(52) U.S. Cl. CPC G06F 3/017; A63F 11/0074; G06F 3/167; G06T 7/62; G06V 20/20; G06V 20/50; G06V 40/28; G09G 3/001; A63F 2011/0086; G06T 2207/10028; G06T 2207/30196; G09G 2354/00

(57) ABSTRACT

Methods, systems, and computing devices for providing contextual feedback within an augmented interaction space are described. A multimodal interactive platform includes a sensing and projection assembly supported by a positioning structure at a first position relative to a surface. An augmented interaction space is defined by an overlapping spatial region in which a field of view of one or more image capture devices and a projection area of one or more projection devices coincide over the surface, the augmented interaction space including both physical objects and projected visual content. A computing system receives image data, obtains a contextual state for an activity based at least in part on one or more physical objects within the augmented interaction space and activity-specific rules, and causes the one or more projection devices to display a projected visual overlay within the augmented interaction space based on the contextual state.

### CROSS-REFERENCE TO RELATED APPLICATION

This application is a U.S. Non-Provisional Patent Application which claims priority to and the benefit of Applicant’s U.S. Provisional Patent Application No. 63/773,556 filed Mar. 18, 2025, and entitled ENHANCED INTERACTIVE SYSTEM WITH AI-POWERED RECOGNITION AND MULTI-USE MODULAR GAMEPLAY & INSTRUCTIONAL ASSISTANCE, which prior application is hereby incorporated by reference in its entirety. It is to be understood, however, that in the event of any inconsistency between this specification and any information incorporated by reference in this specification, this specification shall govern

### FIELD OF TECHNOLOGY

The present disclosure relates generally to multimodal interactive computing platforms, including systems, methods, and computing devices for providing contextual feedback within an augmented interaction space defined over a physical surface using sensing, projection, and computing components.

### BACKGROUND

Interactive computing systems may combine sensing and projection technologies across a range of applications. However, challenges remain in contextually interpreting an activity being performed within such an environment based on physical objects present, evaluating those physical objects against activity-specific rules governing the activity, maintaining an evolving understanding of the activity's state over time and across multiple input modalities, and generating responsive outputs — including projected visual overlays spatially registered within the environment — that reflect that evolving understanding within a unified space in which both the physical objects and the projected content coexist. Further challenges exist with respect to supporting multiple concurrent users within distinct or shared regions of the same space, enabling physically separated spaces to share contextual awareness of physical objects disposed within each space, and leveraging generative models to produce dynamic content in response to the real-time state of an activity.

### BRIEF DESCRIPTION OF THE DRAWINGS

FIG. 1 illustrates an example of a multimodal interactive platform system in accordance with aspects of the present disclosure.

FIG. 2 illustrates an example of an augmented interaction space of a multimodal interactive platform system in accordance with aspects of the present disclosure.

FIG. 3 shows a block diagram of an electronic device that supports a multimodal interactive platform in accordance with aspects of the present disclosure.

FIGS. 4A and 4B show examples of a physical environment and a corresponding digital environment in accordance with aspects of the present disclosure.

FIGS. 5A and 5B show examples of a physical environment and a corresponding digital environment including multiple physical objects in accordance with aspects of the present disclosure.

FIGS. 6A and 6B show examples of physical object tracking and rule enforcement within an augmented interaction space in accordance with aspects of the present disclosure.

FIGS. 7A-7C show examples of gameplay within an augmented interaction space in accordance with aspects of the present disclosure.

FIG. 8 shows an example of a projected user interface in accordance with aspects of the present disclosure.

FIG. 9 shows a system interaction diagram that supports a multimodal interactive platform in accordance with aspects of the present disclosure.

FIG. 10 shows examples of interaction layers of two networked augmented interaction spaces in accordance with aspects of the present disclosure.

FIG. 11 shows a software architecture diagram that supports a multimodal interactive platform in accordance with aspects of the present disclosure.

FIG. 12 shows a software processing architecture that supports a multimodal interactive platform in accordance with aspects of the present disclosure.

FIG. 13 shows an application flow that supports a multimodal interactive platform in accordance with aspects of the present disclosure.

FIG. 14 shows a system architecture diagram that supports a multimodal interactive platform in accordance with aspects of the present disclosure.

FIG. 15 shows a diagram of a system including a device that supports providing contextual feedback within an augmented interaction space in accordance with aspects of the present disclosure.

FIGS. 16 and 17 show flowcharts illustrating methods that support providing contextual feedback within an augmented interaction space in accordance with aspects of the present disclosure.

### DETAILED DESCRIPTION

The present disclosure describes systems, methods, and computing devices for a multimodal interactive platform that combines physical objects and projected digital content within a unified spatial region referred to herein as an augmented interaction space (“AIS”). In an embodiment, the multimodal interactive platform includes a sensing and projection assembly (also referred to herein as an electronic device, an electronics bar, an overhead assembly, or a sensor and projection unit) supported by a positioning structure (also referred to herein as a physical support, a support structure, or a mounting structure) at a first position relative to a surface. The sensing and projection assembly may include one or more image capture devices oriented to capture image data of the surface and a region above the surface, one or more projection devices configured to project visual content onto the surface, and a computing system including one or more processors and one or more memories. The surface (also referred to herein as a projection surface, a surface mat, or an interaction surface) may be any generally planar area on which physical objects may be disposed and onto which the one or more projection devices may display projected visual content. The positioning structure may take various forms including, for example, collapsible tabletop legs, a ceiling mount, an arm mount, a wall mount, a rail system, or any other structure capable of supporting the sensing and projection assembly at a predetermined height and orientation relative to the surface.

The augmented interaction space is defined by an overlapping spatial region in which a field of view of the one or more image capture devices and a projection area of the one or more projection devices coincide over the surface. The augmented interaction space includes both physical objects disposed on or above the surface and projected visual content displayed on the surface by the one or more projection devices. In some embodiments, the augmented interaction space extends volumetrically above the surface such that the one or more image capture devices may capture three-dimensional spatial data of physical objects and user interactions occurring at varying heights above the surface. Because the field of view and the projection area overlap within this defined spatial region, the computing system may simultaneously perceive physical objects within the augmented interaction space and cause the one or more projection devices to display projected visual content that coexists spatially with those physical objects on the surface. In some embodiments, the augmented interaction space may further include a plurality of interaction layers, including at least a physical object layer representing the one or more physical objects disposed on or above the surface and a projected content layer representing the projected visual content displayed on the surface, and the computing system may obtain a contextual state based on a spatial relationship between at least one physical object in the physical object layer and at least one element of the projected content layer.

In operation, the computing system may receive image data from the sensing and projection assembly and may obtain, based on at least the image data, a contextual state for an activity being performed within the augmented interaction space. The contextual state may be based at least in part on one or more physical objects within the augmented interaction space. In some embodiments, the computing system may obtain, based on at least the image data, identification data associated with the one or more physical objects within the augmented interaction space, and the contextual state may be based at least in part on the identification data. Physical objects within the augmented interaction space may include, for example and without limitation, game pieces, playing cards, tokens, instructional components, building blocks, crafting materials, cooking implements, user hands or fingers, or any other tangible item relevant to the activity being performed. The identification data may include, for example, a classification label, a recognized name or title, a barcode or visual code, or any other data by which the computing system can distinguish one physical object from another or determine what the physical object represents within the context of the activity.

In some embodiments, obtaining the contextual state may include evaluating one or more physical objects within the augmented interaction space against a set of activity-specific rules. The set of activity-specific rules may define permissible actions, required sequences, scoring criteria, resource constraints, or other parameters governing the activity. For example, where the activity comprises a tabletop game, the set of activity-specific rules may comprise game rules for the tabletop game, and the contextual state may comprise at least one of a current game phase, a current active player, a game score, or a resource pool associated with a player. Where the activity comprises a guided task or instructional exercise, the set of activity-specific rules may comprise an instructional step sequence for the guided activity, and the contextual state may comprise a current step in the instructional step sequence. The computing system may detect, based on the contextual state, an impermissible action (e.g., an illegal game move, an out-of-order instructional step, or a placement that violates a spatial constraint) and may generate a corrective visual indicator as part of a projected visual overlay displayed within the augmented interaction space. In some embodiments, the computing system may generate a next-step visual overlay indicating a subsequent action to be performed by a user within the augmented interaction space (e.g., a next step while practicing a surgical procedure). The activity-specific rules may be stored locally on the one or more memories, obtained from a remote computing device via a network interface, or derived dynamically through interaction with a language model or other inference system.

In some embodiments, the one or more memories may further store session data including a temporal sequence of previously obtained contextual states for the activity. The computing system may obtain the contextual state based at least in part on the session data, such that the current contextual state reflects not only the present configuration of physical objects within the augmented interaction space but also the history of how the activity has progressed over time. The session data may include at least one of a history of physical object placements within the augmented interaction space, a history of user inputs (including vocal user inputs and gesture inputs), or a history of previously generated response outputs. By maintaining and referencing session data, the computing system may, for example, determine that a particular game piece has been moved multiple times, that a user has previously attempted and failed a particular instructional step, or that a cumulative score has reached a threshold warranting a particular projected visual response.

Based on the contextual state, the computing system may obtain one or more response outputs including at least a projected visual overlay, and may cause the one or more projection devices to display the projected visual overlay within the augmented interaction space. In some embodiments, the one or more response outputs may further include an audio response output, and the computing system may cause one or more audio output devices (e.g., one or more speakers supported by the positioning structure) to present the audio response output. In some embodiments, the audio response output may comprise a spoken-language response corresponding to a vocal user input provided by a user. In some embodiments, the computing system may generate the projected visual overlay and the audio response output in a synchronized manner such that the audio response output corresponds temporally to the projected visual overlay displayed within the augmented interaction space. The projected visual overlay may include, for example and without limitation, position-tracking indicators that follow a physical object in real time, boundary indicators, corrective indicators, next-step indicators, animated effects (e.g., damage animations, transitions, or environmental effects), informational overlays (e.g., text annotations, statistics, or rule summaries), or any other visual content generated in response to the contextual state.

In some embodiments, the sensing and projection assembly may include multimodal sensing capabilities beyond image capture. The sensing and projection assembly may include one or more audio capture devices (e.g., one or more microphones, which in some embodiments may comprise a beamforming microphone array) configured to capture audio data from a vicinity of the surface. The computing system may receive the audio data and may obtain, based on at least the audio data, a vocal user input associated with the activity being performed within the augmented interaction space. The contextual state may be further based on the vocal user input. For example, a user may speak a question regarding a game rule, an instruction to advance to a next phase, or a command to select an activity, and the computing system may incorporate the vocal user input into the determination of the contextual state and the corresponding response outputs. In some embodiments, the one or more image capture devices may include at least one depth sensing device configured to capture three-dimensional spatial data of the augmented interaction space. The depth sensing device may comprise at least one of a time-of-flight sensor, a structured light sensor, or a stereo depth camera. The computing system may determine, based on the three-dimensional spatial data, at least one of a height, a volume, or a contour of one or more physical objects within the augmented interaction space. In some embodiments, the sensing and projection assembly may further comprise at least one LiDAR sensor configured to capture spatial data of the augmented interaction space and a region adjacent to the augmented interaction space. The computing system may detect, based on spatial data from the at least one LiDAR sensor, one or more user gestures performed on, above, or adjacent to the surface, and the contextual state may be further based on the one or more detected user gestures. The computing system may further determine, based on spatial data from the at least one LiDAR sensor, a posture or a proxemic position of one or more users relative to the augmented interaction space. In some embodiments, the one or more image capture devices may include a wide-field camera configured to capture image data spanning a full extent of the augmented interaction space and a narrow-field camera configured to capture image data of a sub-region of the augmented interaction space. The computing system may select, based on the image data from the wide-field camera, the sub-region for capture by the narrow-field camera, enabling higher-resolution identification of physical objects such as cards bearing fine text, detailed illustrations, or small symbols.

In some embodiments, the one or more projection devices may comprise a plurality of projection devices configured with overlapping projection areas to reduce shadow caused by three-dimensional physical objects within the augmented interaction space. Because the augmented interaction space accommodates physical objects of varying heights and geometries, a single projection device projecting from one angle may produce shadows behind or adjacent to taller physical objects, obscuring portions of the projected visual content. By using a plurality of projection devices with overlapping projection areas from different angles, the computing system may ensure that the projected visual overlay remains visible around and near three-dimensional physical objects on the surface. In some embodiments, one or more of the response outputs may include a generated visual asset obtained by transmitting, via a network interface, a content generation request to a remote generative model and receiving, from the remote generative model, the generated visual asset. For example, the computing system may request a dynamically generated animation, illustration, or texture from a remote generative model (e.g., a generative image model, a generative video model, or a multimodal generative model) and may incorporate the generated visual asset into the projected visual overlay.

In some embodiments, the multimodal interactive platform may further comprise a network interface communicatively coupled to the computing system. The computing system may transmit, via the network interface, at least a portion of the image data or at least a portion of the contextual state to a remote computing device, and may receive, via the network interface, remote image data or remote contextual data from the remote computing device. The remote image data or remote contextual data may represent one or more physical objects disposed within a remote interaction space associated with the remote computing device. In some embodiments, the computing system may obtain, based on the remote image data or the remote contextual data, a visual representation of at least one physical object from the remote interaction space, and may cause the one or more projection devices to display the visual representation within the augmented interaction space. In some embodiments, the visual representation may be displayed within the augmented interaction space at a position corresponding to a position of the at least one physical object within the remote interaction space, thereby enabling position-mapped remote physical object projection. In some embodiments, the remote computing device may comprise a second multimodal interactive platform including a second sensing and projection assembly, and the two platforms may synchronize contextual state data for a shared activity being performed across both augmented interaction spaces. In other embodiments, the remote computing device may comprise a user device (e.g., a smartphone, tablet, or laptop) including a camera, and the remote image data may comprise image data captured by the camera of the user device and transmitted to the computing system via the network interface.

In some embodiments, the augmented interaction space may be partitioned into a plurality of zones, each zone associated with a respective user of a plurality of users. The computing system may obtain a respective contextual state for each zone based on the one or more physical objects within that zone, and may cause the one or more projection devices to display a respective projected visual overlay within each zone. In some embodiments, at least one zone of the plurality of zones may comprise a shared zone accessible to two or more users, and the contextual state for the shared zone may be based on physical objects disposed within the shared zone by any of the two or more users. For example, in a multi-player tabletop game, each player may have a dedicated zone for their game components, while a central region of the surface may serve as a shared zone representing a shared play area (e.g., a battlefield, a discard pile, or a common workspace).

In some embodiments, the multimodal interactive platform may further be associated with a companion application executing on a mobile computing device communicatively coupled to the computing system. The companion application may be configured to provide at least one of user profile management, activity library selection, system configuration, or performance analytics display. The multimodal interactive platform may further support an extensible application ecosystem through an application programming interface (referred to herein as TowerAPI or a platform API) and a software development kit (referred to herein as Tower SDK or a platform SDK). Third-party developers and first-party developers may create applications for the platform using the SDK, and such applications may be distributed through a platform application store, a third-party application store, or both. The platform's software architecture may separate system-level functions (e.g., device management, sensor processing, and state tracking) from application-level functions (e.g., activity-specific game logic, instructional sequences, and rendered scenes), enabling modularity and extensibility across diverse activities and use cases.

While the foregoing provides a general overview of various aspects of the multimodal interactive platform, additional details, alternative embodiments, and specific implementations are described below with reference to the accompanying drawings. The systems and methods described herein are not limited to any particular activity, physical object type, or positioning structure configuration, and one of ordinary skill in the art will appreciate that the principles described herein may be applied across a wide range of interactive, educational, instructional, recreational, professional, and social applications.

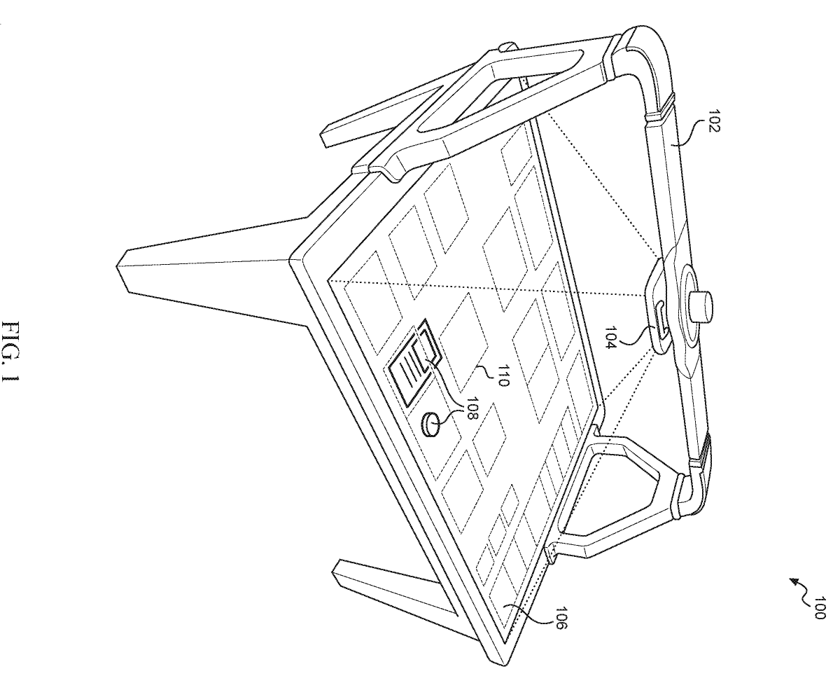

FIG. 1 illustrates an example of a multimodal interactive platform system 100, in accordance with aspects of the present disclosure. In an embodiment, the system 100 includes a positioning structure 102 configured to support a sensing and projection assembly 104 at a first position relative to a surface 106. In the embodiment shown in FIG. 1, the positioning structure 102 comprises a tabletop stand including collapsible legs that elevate the sensing and projection assembly 104 to a predetermined height above the surface 106. The predetermined height may be calculated to ensure that a field of view of one or more image capture devices within the sensing and projection assembly 104 encompasses the surface 106 and a region above the surface 106, that a projection area of one or more projection devices within the sensing and projection assembly 104 covers at least a substantial portion of the surface 106, and that the sensing and projection assembly 104 is positioned outside a primary line of sight of users seated or standing around the surface 106 so as not to obstruct user interaction. In some embodiments, the predetermined height may further account for spacing to accommodate a desired number of concurrent users (e.g., up to four users in the embodiment of FIG. 1, though more or fewer users may be accommodated in other embodiments) and for focal clarity of the one or more projection devices at the projection distance. The positioning structure 102 is not limited to the tabletop stand configuration shown in FIG. 1, and may alternatively comprise, for example, a ceiling mount, a wall mount, an arm mount (including a robotic or swing arm), a rail system, or any other structure capable of supporting the sensing and projection assembly 104 at a fixed or adjustable position relative to the surface 106.

The surface 106 may comprise any generally planar area suitable for disposing physical objects and receiving projected visual content. In some embodiments, the surface 106 may comprise a projection surface mat that is placed on a supporting surface such as a tabletop or floor. The projection surface mat may include features for alignment with the positioning structure 102, such as magnetic alignment points, clips, or other registration features. In some embodiments, the projection surface mat may be interchangeable, and different projection surface mats may be associated with different activities (e.g., a gaming mat, an instructional mat, a crafting mat, or a mat with specialized material properties such as heat resistance or a dry-erase coating). In other embodiments, the surface 106 may comprise a bare tabletop, a floor surface, a desk surface, or any other surface onto which the one or more projection devices may project visual content.

As shown in FIG. 1, the AIS of the system 100 encompasses both physical objects 108 disposed on or above the surface 106 and projections 110 displayed on the surface 106 by the one or more projection devices of the sensing and projection assembly 104. The physical objects 108 may include, for example, game pieces, playing cards, tokens, instructional components, user hands, or any other tangible items placed within the AIS. The projections 110 may include background visual content (e.g., a game board layout, an instructional workspace, or a decorative environment), as well as projected visual overlays generated in response to a contextual state, as described herein. The coexistence of physical objects 108 and projections 110 within the same spatial region on and above the surface 106 enables the computing system of the sensing and projection assembly 104 to simultaneously perceive the physical objects 108 via the one or more image capture devices and display contextually responsive projected visual content via the one or more projection devices. In some embodiments, the positioning structure 102 may be collapsible or foldable for portability and storage, and may include features such as locking hinges, wheels, or a carrying case to facilitate transport.

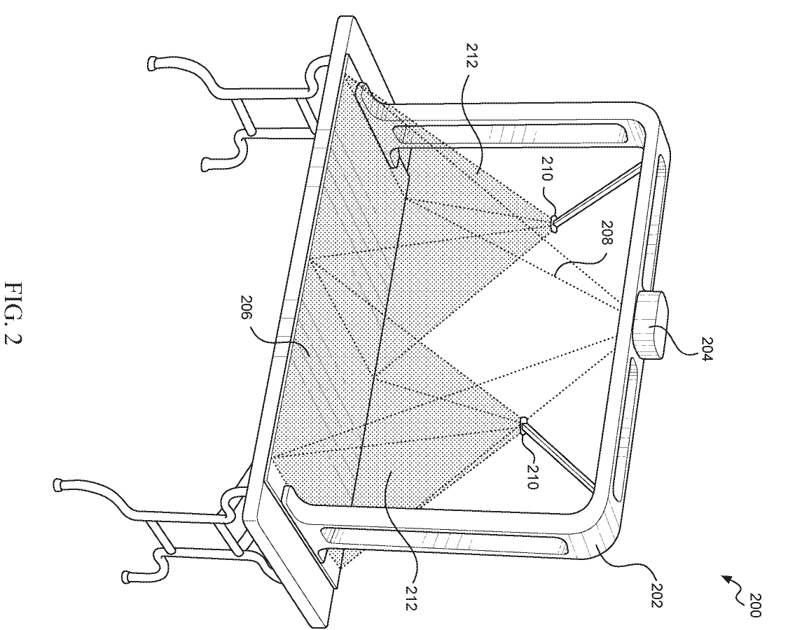

FIG. 2 illustrates an example of a multimodal interactive platform system 200 with emphasis on the augmented interaction space (AIS) 208, in accordance with aspects of the present disclosure. As in the embodiment of FIG. 1, the system 200 includes a positioning structure 202 supporting a sensing and projection assembly 204 at a first position relative to a surface 206. FIG. 2 depicts the AIS 208 as a volumetric region extending from the sensing and projection assembly 204 toward and encompassing the surface 206. The AIS 208 represents the overlapping spatial region in which a field of view of the one or more image capture devices within the sensing and projection assembly 204 and a projection area of the one or more projection devices within the sensing and projection assembly 204 coincide over the surface 206. As shown in the embodiment of FIG. 2, the AIS 208 may have a generally conical or pyramidal shape originating at or near the sensing and projection assembly 204 and expanding toward the surface 206, though the precise shape of the AIS 208 may vary depending on the optics of the one or more image capture devices and the one or more projection devices, and the AIS 208 is not limited to any particular geometric form.

Within the AIS 208, physical objects disposed on or above the surface 206 and projected visual content displayed on the surface 206 by the one or more projection devices coexist within the same spatial region. This coexistence enables the computing system to simultaneously perceive the physical objects via the one or more image capture devices and display contextually responsive projected visual content via the one or more projection devices, such that the projected visual content may be spatially registered to, adjacent to, overlaid upon, or otherwise visually associated with one or more of the physical objects. In some embodiments, the AIS 208 extends volumetrically above the surface 206 to a height sufficient to capture three-dimensional spatial data of physical objects and user interactions occurring at varying elevations above the surface 206. For example, the AIS 208 may encompass not only flat objects resting on the surface 206 (e.g., playing cards, tokens, or instructional documents) but also three-dimensional objects extending above the surface 206 (e.g., game figurines, stacked building blocks, a user's hand, or a user's arm reaching into the AIS 208). The volumetric extent of the AIS 208 may be determined at least in part by the predetermined height of the sensing and projection assembly 204 above the surface 206, the field of view angles of the one or more image capture devices, and the projection throw ratio and angle of the one or more projection devices.

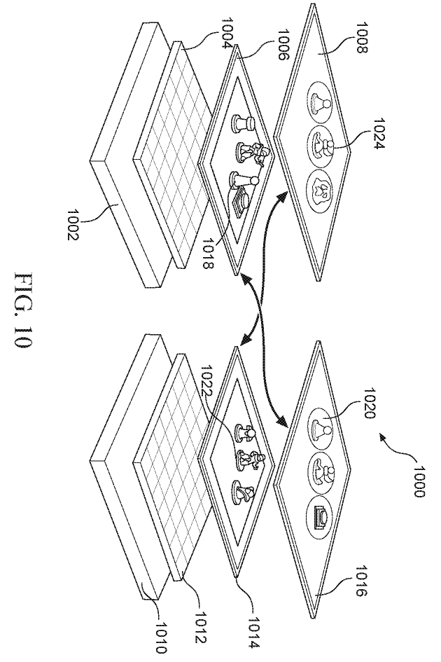

In some embodiments, the AIS 208 may further comprise a plurality of interaction layers, as described herein with respect to FIG. 10. The interaction layers may include at least a physical object layer representing the one or more physical objects disposed on or above the surface 206 and a projected content layer representing the projected visual content displayed on the surface 206. The computing system may obtain a contextual state based on a spatial relationship between at least one physical object in the physical object layer and at least one element of the projected content layer. For example, the computing system may determine that a physical object has been placed on or moved to a location within a projected boundary, zone, or region, and may update the contextual state accordingly. The layered structure of the AIS 208 provides a conceptual framework by which the computing system may distinguish between sensed physical elements and generated digital elements while processing both within a unified spatial context.

As shown in FIG. 2, the system 200 may further include one or more supplemental electronic components 210 extending from or supported by the positioning structure 202. The one or more supplemental electronic components 210 may include, for example, additional image capture devices, additional projection devices, speakers, microphones, ambient lighting devices, or any combination thereof. In the embodiment of FIG. 2, the supplemental electronic components 210 comprise additional cameras disposed on opposing sides of the sensing and projection assembly 204, each having a respective field of view that partially overlaps with the AIS 208. The overlapping coverage provided by the supplemental electronic components 210 defines one or more supplemented augmented interaction spaces 212 that extend or reinforce sensing and projection capabilities within and adjacent to the AIS 208. In some embodiments, the supplemental electronic components 210 may comprise ambient lighting devices synchronized with the projected visual content displayed within the AIS 208, enabling coordinated environmental lighting effects (e.g., color-matched or reactive illumination of the surrounding area) that enhance user immersion within and around the augmented interaction space.

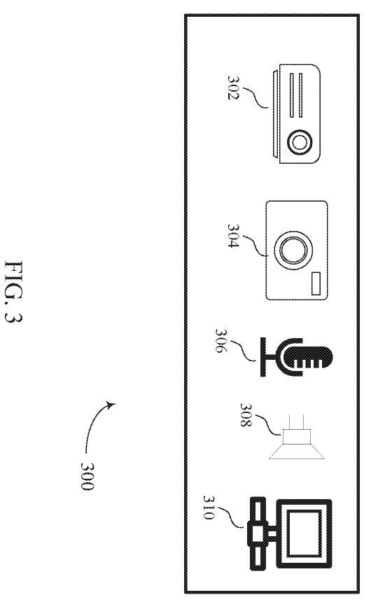

FIG. 3 illustrates a block diagram of a sensing and projection assembly, shown as electronic device 300, in accordance with aspects of the present disclosure. In an embodiment, the electronic device 300 includes a projector 302, a camera 304, a microphone 306, a speaker 308, and a computing system 310. The computing system 310 may include one or more processors (e.g., a central processing unit, a graphics processing unit, a neural processing unit, or a combination thereof), one or more memories (e.g., RAM, ROM, flash storage, or a solid-state drive), and one or more input/output peripheral interfaces. Although FIG. 3 illustrates a single instance of each component for clarity, the electronic device 300 may include multiple instances of any component (e.g., a plurality of projectors, a plurality of cameras, a plurality of microphones, or a plurality of speakers), and may further include additional sensors and output devices not shown in FIG. 3, as described below.

In an embodiment, projector 302 represents one or more projection devices configured to project visual content onto the surface within the AIS. The one or more projection devices may comprise any suitable projection technology including, for example, digital light processing (DLP) projectors, liquid crystal display (LCD) projectors, laser projectors, light-emitting diode (LED) projectors, or pico projectors. In some embodiments, the one or more projection devices may include a plurality of projection devices configured with overlapping projection areas to reduce shadow caused by three-dimensional physical objects within the AIS. Because the AIS accommodates physical objects of varying heights and geometries (e.g., game figurines, stacked blocks, a user's hand), a single projection device projecting from one angle may produce shadows behind or adjacent to taller physical objects, partially obscuring projected visual content on the surface. By positioning a plurality of projection devices at different angles within the sensing and projection assembly, the overlapping projection areas may ensure that the projected visual overlay remains visible around and near three-dimensional physical objects. In some embodiments, the one or more projection devices may include adjustable brightness and ambient light adaptation to maintain visibility under varying lighting conditions.

In an embodiment, camera 304 represents one or more image capture devices oriented to capture image data of the surface and a region above the surface. The one or more image capture devices may include a two-dimensional (2D) RGB camera for capturing color image data, and may further include at least one depth sensing device configured to capture three-dimensional spatial data of the AIS. The depth sensing device may comprise at least one of a time-of-flight (ToF) sensor, a structured light sensor, or a stereo depth camera. Based on the three-dimensional spatial data, the computing system 310 may determine at least one of a height, a volume, or a contour of one or more physical objects within the AIS, enabling the system to distinguish, for example, a flat playing card from a three-dimensional game figurine. In some embodiments, the one or more image capture devices may include a wide-field camera configured to capture image data spanning a full extent of the AIS and a narrow-field camera configured to capture image data of a sub-region of the AIS at higher resolution. The computing system 310 may select, based on the image data from the wide-field camera, the sub-region for capture by the narrow-field camera. This dual-camera architecture enables the system to maintain broad spatial awareness of the entire AIS while obtaining higher-resolution image data sufficient for identifying fine-detail physical objects such as playing cards bearing small text, detailed illustrations, or visual codes. In some embodiments, the electronic device 300 may further include at least one LiDAR sensor (not shown separately in FIG. 3) configured to capture spatial data of the AIS and a region adjacent to the AIS. The computing system 310 may detect, based on spatial data from the at least one LiDAR sensor, one or more user gestures performed on, above, or adjacent to the surface, and may further determine a posture or a proxemic position of one or more users relative to the AIS. The LiDAR sensor may be used in conjunction with the depth sensing device and the one or more image capture devices to improve object tracking, spatial mapping, and gesture recognition accuracy.

In an embodiment, microphone 306 represents one or more audio capture devices configured to capture audio data from a vicinity of the surface. In some embodiments, the one or more audio capture devices may comprise a beamforming microphone array capable of directional audio capture, enabling the computing system 310 to isolate vocal user inputs from ambient noise and to attribute voice commands to specific users based on direction of arrival. Speaker 308 represents one or more audio output devices configured to present audio response outputs, including spoken-language responses, sound effects, and instructional audio. In some embodiments, the computing system 310 may generate the projected visual overlay and the audio response output in a synchronized manner such that the audio response output corresponds temporally to the projected visual overlay displayed within the AIS.

The computing system 310 may be implemented using a system-on-chip (SoC), a single-board computer (SBC), or a modular computing architecture comprising discrete components connected via standard buses. In an embodiment, the one or more image capture devices may be connected to the computing system 310 via a MIPI CSI (Camera Serial Interface) or USB interface. The one or more projection devices may be connected via an HDMI, MIPI DSI (Display Serial Interface), or other suitable video output interface. The one or more audio capture devices and the one or more audio output devices may be connected via I2S, USB, or analog audio interfaces. Additional sensors (e.g., the at least one LiDAR sensor, pressure sensors for a pressure-sensitive mat, ambient light sensors, accelerometers, or infrared illuminators) may be connected via SPI, I2C, USB, or other suitable peripheral interfaces. The computing system 310 may further include a network interface (e.g., Wi-Fi, Bluetooth, Ethernet, or a combination thereof) for communication with remote computing devices, cloud services, companion applications, and other multimodal interactive platforms. Thermal management for the electronic device 300 may include passive heatsinks, active fan cooling, or a combination thereof within a housing of the sensing and projection assembly.

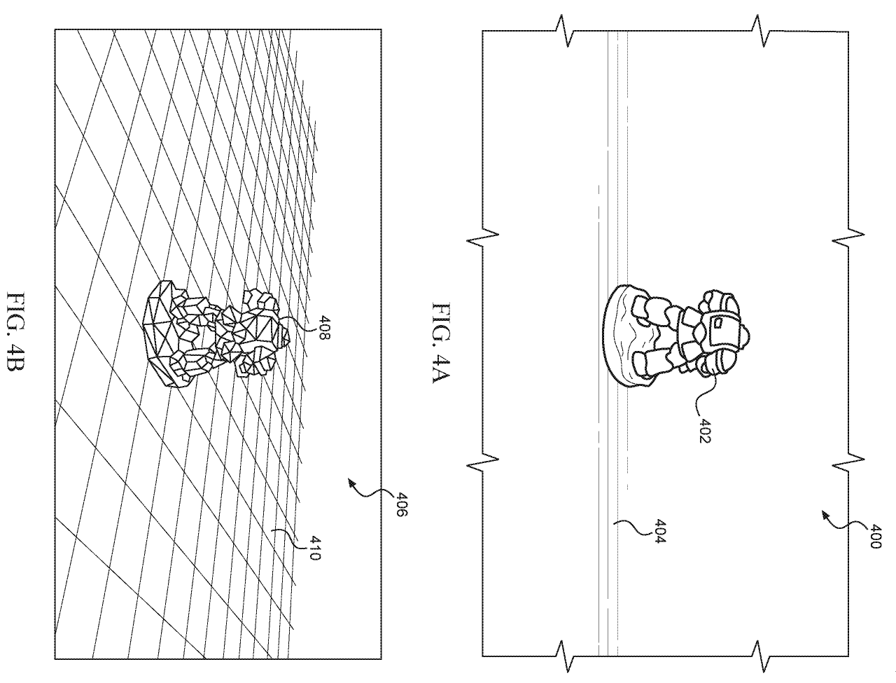

FIGS. 4A and 4B illustrate a physical environment and a corresponding digital environment, respectively, in accordance with aspects of the present disclosure. FIG. 4A depicts a physical environment 400 in which a physical object 402 (e.g., a game piece) is disposed on a surface 404. The surface 404 may include a background projection displayed by the one or more projection devices. FIG. 4B depicts a digital environment 406 representing the computing system's internal representation of the physical environment 400. The digital environment 406 includes a digital embodiment 408 of the physical object 402 and a digital embodiment 410 of the surface 404.

In an embodiment, the computing system generates the digital environment 406 by processing image data captured by the one or more image capture devices within the AIS. The digital embodiment 408 may include identification data associated with the physical object 402, such as a classification label, a recognized name or title, a spatial position, a bounding region, an orientation, or other data by which the computing system distinguishes the physical object 402 from other objects and from the surface 404. In some embodiments, the digital embodiment 408 may further include dimensional data (e.g., height, volume, or contour information derived from three-dimensional spatial data) and confidence scores associated with the identification. The digital embodiment 410 of the surface 404 may represent the projection background, the mat texture, or the bare surface, and may serve as a spatial reference frame against which the position and movement of the digital embodiment 408 are tracked. The digital environment 406 provides the internal representation from which the computing system obtains the contextual state and against which activity-specific rules are evaluated. In some embodiments, a portion or all of the digital environment 406 may be transmitted to a remote computing device to enable networked operation, as described herein with respect to FIG. 10.

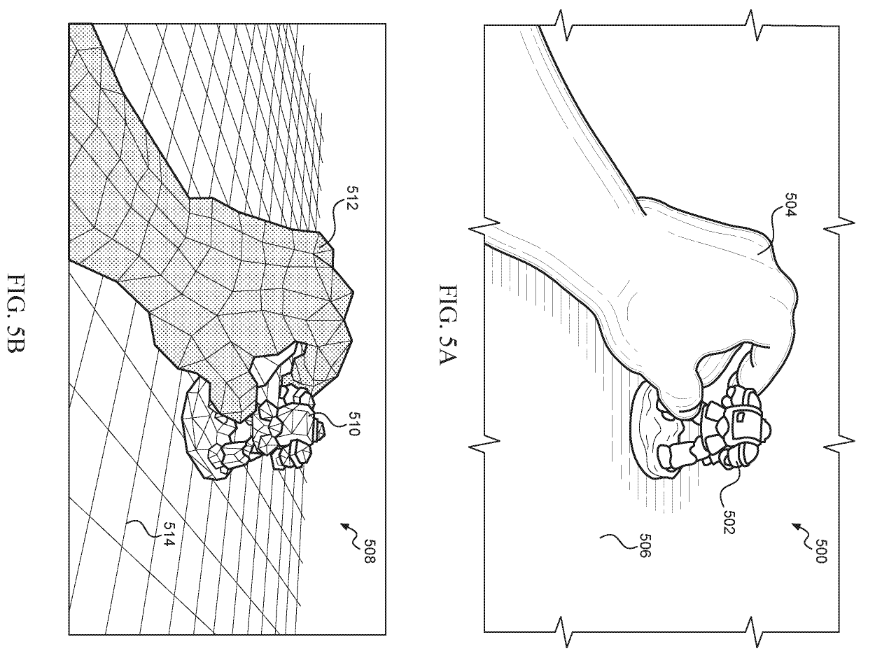

FIGS. 5A and 5B illustrate a physical environment and a corresponding digital environment, respectively, in which multiple physical objects of different types are simultaneously present within the AIS, in accordance with aspects of the present disclosure. FIG. 5A depicts a physical environment 500 including a first physical object 502 (e.g., a game piece), a second physical object 504 (e.g., a user's hand), and a surface 506 which may include a background projection. FIG. 5B depicts a digital environment 508 including a first digital embodiment 510 of the first physical object 502, a second digital embodiment 512 of the second physical object 504, and a digital embodiment 514 of the surface 506.

In an embodiment, the computing system simultaneously recognizes and distinguishes between physical objects of different types within the AIS. The first physical object 502 may be classified as an activity-relevant object (e.g., a game piece, a card, or an instructional component), while the second physical object 504 may be classified as a user interaction input (e.g., a hand, finger, or arm). The second digital embodiment 512 may enable the computing system to detect one or more user gestures, such as reaching, grasping, pointing, or placing, based on the shape, position, and movement of the second physical object 504 over successive frames of image data. In some embodiments, the computing system may use three-dimensional spatial data (e.g., from a depth sensing device or a LiDAR sensor) to determine the height and contour of the second physical object 504 above the surface 506, enabling the system to distinguish between a hand hovering above the surface and a hand touching or manipulating an object on the surface. The contextual state may be based on the spatial relationship between the first physical object 502 and the second physical object 504—for example, the computing system may determine that the user's hand 504 is grasping, moving, or releasing the game piece 502, and may update the contextual state accordingly.

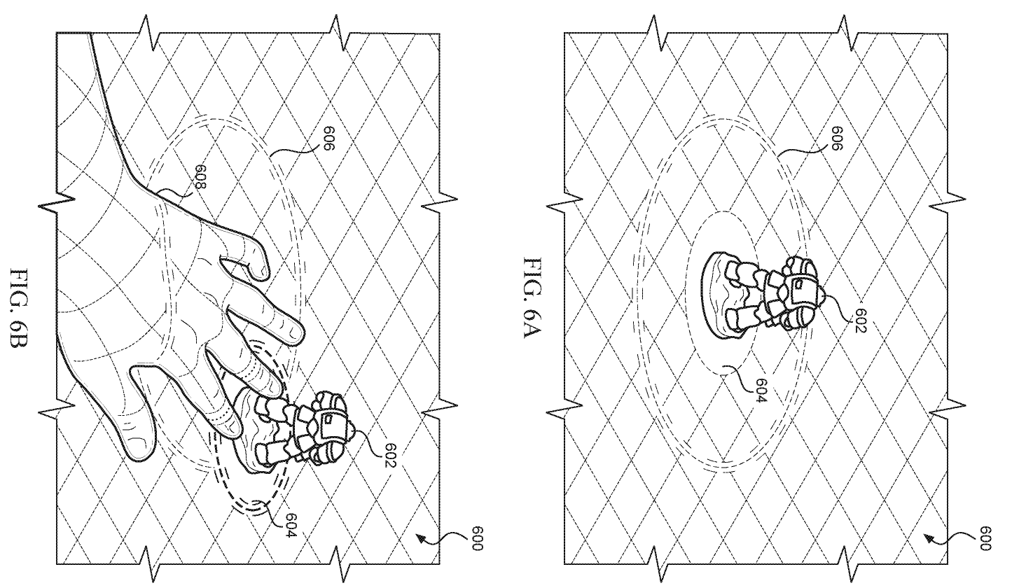

FIGS. 6A and 6B illustrate real-time physical object tracking and activity-specific rule enforcement within the AIS, in accordance with aspects of the present disclosure. FIG. 6A depicts a physical environment 600 in which a physical object 602 (e.g., a game piece) is disposed on the surface. A physical object position area 604 is projected around or beneath the physical object 602 by the one or more projection devices. The physical object position area 604 is a projected visual overlay generated by the computing system based on the tracked position of the physical object 602, and moves in real time as the physical object 602 is moved within the AIS. The physical object position area 604 may take any suitable visual form, including a colored highlight, an outline, a glow effect, a shadow, or an animated indicator, and may encode contextual information such as the identity, status, or ownership of the physical object 602 (e.g., a color corresponding to a particular player, or an icon indicating the object's role within the activity).

FIG. 6B depicts the physical environment 600 in which a second physical object 608 (e.g., a user's hand) moves the physical object 602 toward a boundary 606 projected on the surface by the one or more projection devices. The boundary 606 represents a spatial constraint derived from the set of activity-specific rules for the activity being performed. For example, in a tabletop game, the boundary 606 may represent the edge of a legal play zone, a territory border, or a movement range limit. In a guided instructional activity, the boundary 606 may represent a designated placement area for an instructional step, a keep-out zone, or a measurement threshold. Upon the physical object 602 reaching or crossing the boundary 606, the computing system detects, based on the contextual state, that the physical object 602 has met the spatial constraint, and the physical object position area 604 provides visual feedback indicating this event. The visual feedback may include a change in color, shape, size, animation, or opacity of the physical object position area 604. In some embodiments, the feedback may additionally or alternatively include an audio response output (e.g., a confirmation tone, a warning sound, or a spoken-language notification) or a haptic response (e.g., via a haptic feedback device or a vibration in a pressure-sensitive mat).

FIGS. 6A and 6A together illustrate the computing system's ability to close an embodiment of a contextual feedback loop described herein: the computing system (i) captures image data of the physical object 602, (ii) tracks the position of the physical object 602 in real time, (iii) evaluates the position against the set of activity-specific rules (including the boundary 606), (iv) obtains a contextual state reflecting the spatial relationship between the physical object 602 and the boundary 606, and (v) generates a projected visual overlay (the physical object position area 604 and its visual feedback) as a response output based on the contextual state. In some embodiments, the computing system may detect that movement of the physical object 602 beyond the boundary 606 constitutes an impermissible action and may generate a corrective visual indicator as part of the projected visual overlay, such as a red highlight, a flashing warning, or a projected arrow indicating that the physical object 602 should be returned to a permissible region. In some embodiments, the computing system may instead detect that placement of the physical object 602 within or at the boundary 606 constitutes a completed step in an instructional step sequence and may generate a next-step visual overlay indicating a subsequent action to be performed by the user within the AIS. The particular feedback generated depends on the set of activity-specific rules loaded for the current activity and the contextual state at the time of the event.

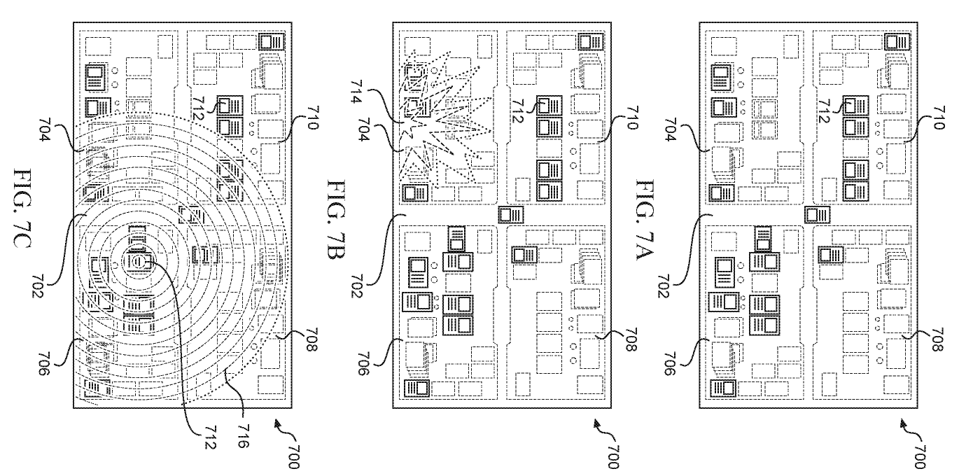

FIGS. 7A through 7C illustrate an example of gameplay using the multimodal interactive platform, in accordance with aspects of the present disclosure. The example depicts a four-player session of a tabletop card game (e.g., Magic: The Gathering) to illustrate how the computing system identifies physical objects, evaluates activity-specific rules, maintains session data, and generates contextually responsive projected visual overlays and audio outputs during a multi-user activity. The gameplay example is illustrative and not limiting; the same principles may apply to any activity supported by the platform.

FIG. 7A depicts a gameplay area 700 including a surface with a projection background 702. The AIS is partitioned into a plurality of zones: a first player area 704, a second player area 706, a third player area 708, and a fourth player area 710, each associated with a respective user. A physical object 712 (e.g., a playing card) is disposed within the AIS. In an embodiment, the computing system obtains a respective contextual state for each zone based on the one or more physical objects within that zone and causes the one or more projection devices to display a respective projected visual overlay within each zone. For example, the projected visual overlay within each player area may include a displayed life total, a mana pool indicator, a game phase indicator, and a turn-order indicator, each derived from the contextual state. The computing system may identify physical object 712 using the one or more image capture devices (e.g., using the narrow-field camera to resolve card text and artwork) and may obtain identification data including the card name, type, and game-relevant attributes. In some embodiments, portions of the gameplay area 700 between or among the player areas 704–710 may comprise a shared zone accessible to two or more users, such as a shared battlefield, a stack zone, or a discard area, and the contextual state for the shared zone may be based on physical objects disposed within the shared zone by any of the users.

FIG. 7B depicts the gameplay area 700 with a damage effect 714 displayed as a projected visual overlay within the first player area 704. The damage effect 714 represents a visual display of damage being applied to the first player, generated by the computing system based on the contextual state. In an embodiment, the computing system determines, based on the contextual state (including identification of attacking and blocking creatures, declared combat assignments, and applicable game rules), that damage is to be dealt to the first player. The computing system generates the damage effect 714 as a projected visual overlay and may simultaneously generate an audio response output (e.g., an impact sound effect) synchronized with the damage effect 714. The computing system may further update the contextual state to reflect the resulting change in the first player's life total, and may cause the projected visual overlay within the first player area 704 to display the updated life total. This illustrates an embodiment of the synchronized audio-visual response described herein, in which the projected visual overlay and the audio response output correspond temporally.

FIG. 7C depicts a physical object 712 (e.g., a card such as "Wrath of God") affecting the entire gameplay area 700 with a board-wide effect 716. In an embodiment, the computing system identifies the physical object 712, obtains identification data (e.g., the card name and rules text), and evaluates the card against the set of activity-specific rules (e.g., the game rules for the tabletop card game). The computing system determines, based on the contextual state and the session data, the ramifications of the card across all zones. For example, the computing system may reference the session data, including the temporal sequence of previously obtained contextual states, to determine which creatures are currently in play across all player areas, which creatures have attributes (e.g., indestructible, hexproof) that modify the effect, and what the resulting board state should be after the card resolves. The computing system generates the board-wide effect 716 as a projected visual overlay spanning multiple zones, accompanied by a corresponding audio response, and updates the contextual state for each affected zone accordingly. This illustrates the role of session data in enabling the computing system to correctly resolve complex, multi-step interactions that depend on the cumulative history of the activity. In some embodiments, the computing system may detect, based on the contextual state, an impermissible game action (e.g., a player attempting to play a card without sufficient resources or during an incorrect game phase) and may generate a corrective visual indicator as part of the projected visual overlay. Users may also provide vocal user inputs (e.g., asking a question about a rule interaction), and the computing system may generate a spoken-language response based on the contextual state and the set of activity-specific rules.

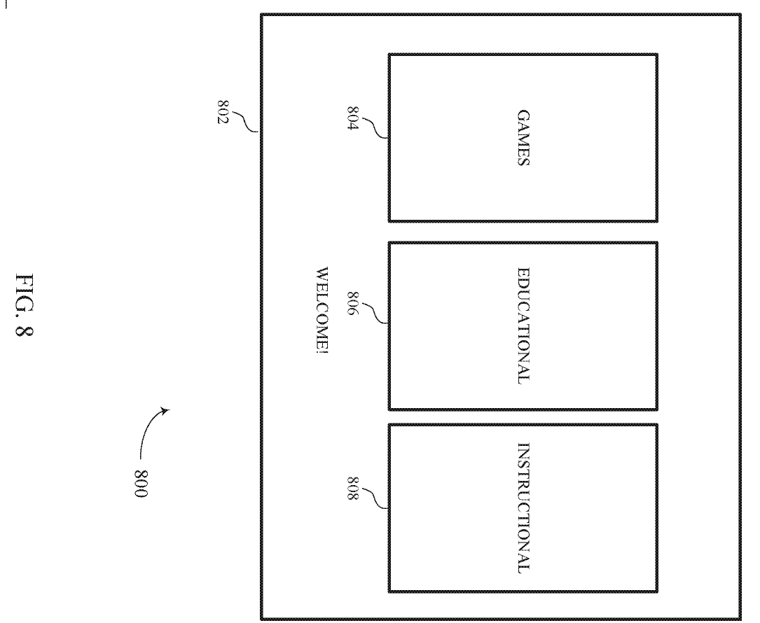

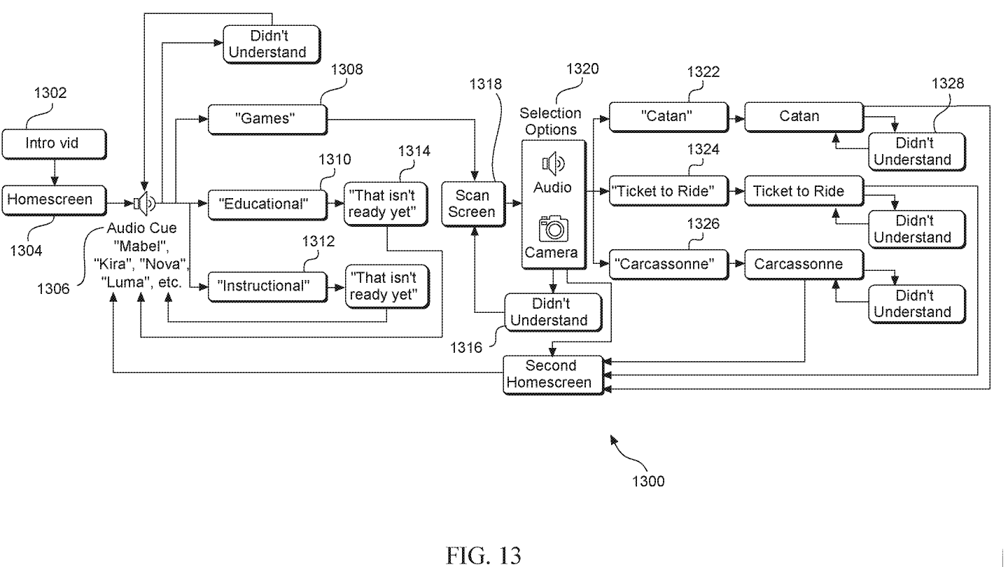

FIG. 8 illustrates a user interface 800 projected onto a surface 802 by the one or more projection devices, in accordance with aspects of the present disclosure. In an embodiment, the user interface 800 is displayed within the AIS as a projected visual overlay presenting a plurality of activity category branches from which a user may select an activity to perform within the AIS. As shown in FIG. 8, the user interface 800 includes a first activity category branch 804 (e.g., games), a second activity category branch 806 (e.g., educational activities), and a third activity category branch 808 (e.g., instructional activities). The activity category branches shown in FIG. 8 are illustrative and not limiting; additional or different activity categories may be presented depending on the platform configuration, available applications, user profile preferences, or subscription status. The user interface 800 may be navigated via vocal user input, gesture input, or input from a companion application, as described herein with respect to FIG. 13.

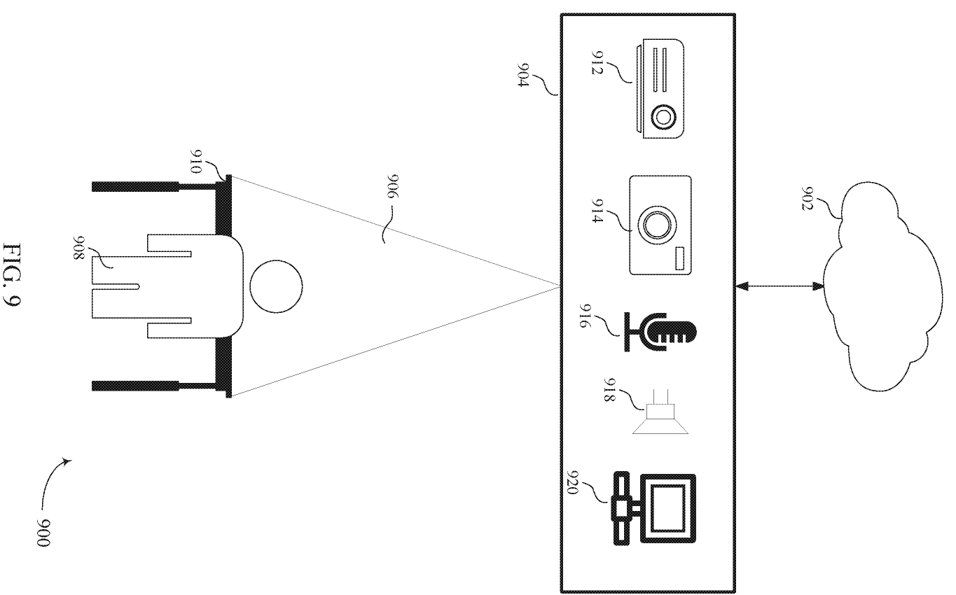

FIG. 9 illustrates a system interaction diagram 900 depicting the operational context of the multimodal interactive platform, in accordance with aspects of the present disclosure. As shown in FIG. 9, a user 908 interacts within an AIS 906 defined over a surface 910. An electronic device 904 (e.g., the sensing and projection assembly described herein) is supported above the surface 910 and includes a projector 912, a camera 914, a microphone 916, a speaker 918, and a computing system 920 including one or more processors, one or more memories, and input/output peripheral devices. The electronic device 904 is communicatively coupled to a cloud 902 via a network interface.

In an embodiment, the cloud 902 may provide one or more remote services to the computing system 920, including remote machine learning inference (e.g., cloud-based vision APIs for object classification, remote speech-to-text services), access to one or more large language models for natural language understanding and rule interpretation, activity-specific rules databases, remote generative models for generating visual assets, and remote synchronization services for networked operation with one or more additional multimodal interactive platforms or user devices. The division of processing between the computing system 920 and the cloud 902 may be flexible; in some embodiments, one or more processing functions (e.g., object detection, voice transcription, contextual state evaluation) may execute locally on the computing system 920, while in other embodiments, one or more of these functions may execute on a remote computing device accessible via the cloud 902. In yet other embodiments, a hybrid approach may be employed in which portions of a processing function execute locally and other portions execute remotely. The cloud 902 may further provide backend services for a companion application executing on a mobile computing device communicatively coupled to the computing system 920.

FIG. 10 illustrates a representation of layers 1000 of two augmented interaction spaces associated with two multimodal interactive platforms in networked communication, in accordance with aspects of the present disclosure. As shown in FIG. 10, a first system includes a first surface 1002, a first background layer 1004, a first physical object layer 1006, and a first projection layer 1008. A second system includes a second surface 1010, a second background layer 1012, a second physical object layer 1014, and a second projection layer 1016. Each AIS is represented as a stack of interaction layers disposed above and on the respective surface. In an embodiment, the physical object layer (e.g., first physical object layer 1006, second physical object layer 1014) represents one or more physical objects disposed on or above the respective surface, and the projection layer (e.g., first projection layer 1008, second projection layer 1016) represents projected visual content displayed on the respective surface by the one or more projection devices. The background layer (e.g., first background layer 1004, second background layer 1012) represents static or persistent visual content projected onto the surface, such as a game board layout, an instructional workspace background, or a decorative environment. The computing system may obtain a contextual state based on the spatial relationship between at least one physical object in the physical object layer and at least one element of the projected content layer, as described herein.

In an embodiment, first physical objects 1018 within the first physical object layer 1006 are captured by the one or more image capture devices of the first system, and at least a portion of the captured image data or derived contextual data is transmitted, via a network interface, to the second system. The second system receives the transmitted data and generates a digital representation of the first physical objects 1020, which is displayed within the second projection layer 1016 by the one or more projection devices of the second system. Bidirectionally, second physical objects 1022 within the second physical object layer 1014 are captured by the second system, transmitted to the first system, and displayed as a digital representation of the second physical objects 1024 within the first projection layer 1008. In some embodiments, the digital representations 1020 and 1024 are displayed within the respective projection layers at positions corresponding to the positions of the physical objects on the originating surface, thereby enabling position-mapped remote physical object projection. For example, if a first physical object 1018 is disposed at a particular coordinate on the first surface 1002, the digital representation 1020 may be projected at a corresponding coordinate on the second surface 1010.

In some embodiments, the two systems may synchronize contextual state data for a shared activity being performed across both augmented interaction spaces. For example, in a networked tabletop game session, the contextual state may reflect game actions taken by users at both systems, and the activity-specific rules may be evaluated collectively across both platforms. In some embodiments, one or both of the networked systems may comprise a full multimodal interactive platform as described herein. In other embodiments, one of the networked systems may comprise a user device (e.g., a smartphone, tablet, or laptop) including a camera, and the remote image data may comprise image data captured by the camera of the user device and transmitted to the multimodal interactive platform via the network interface. The layered representation shown in FIG. 10 is conceptual and illustrative; the computing system may implement the interaction layers using any suitable data structures, rendering pipelines, or spatial mapping techniques.

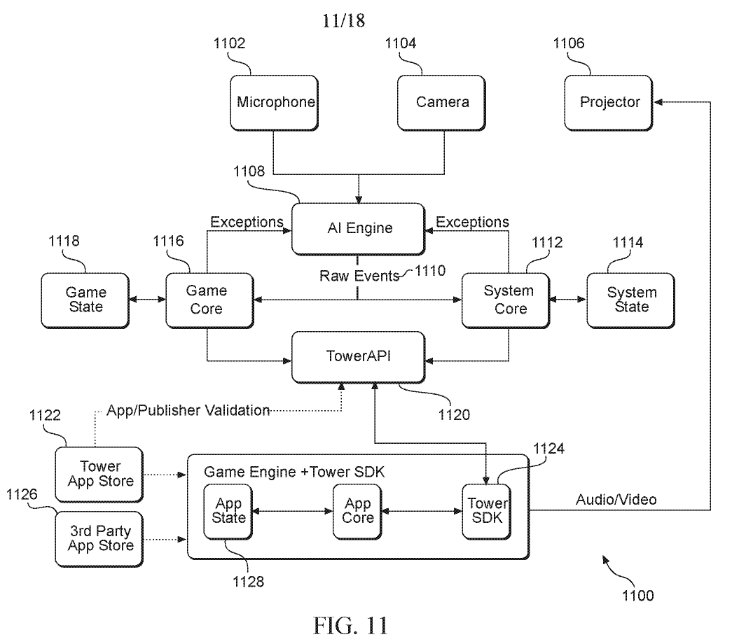

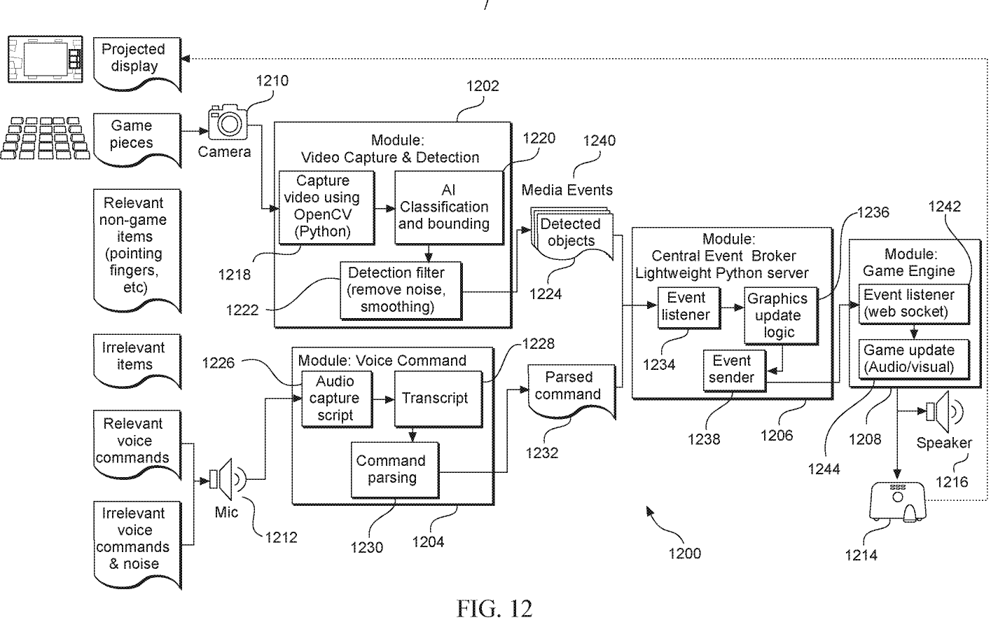

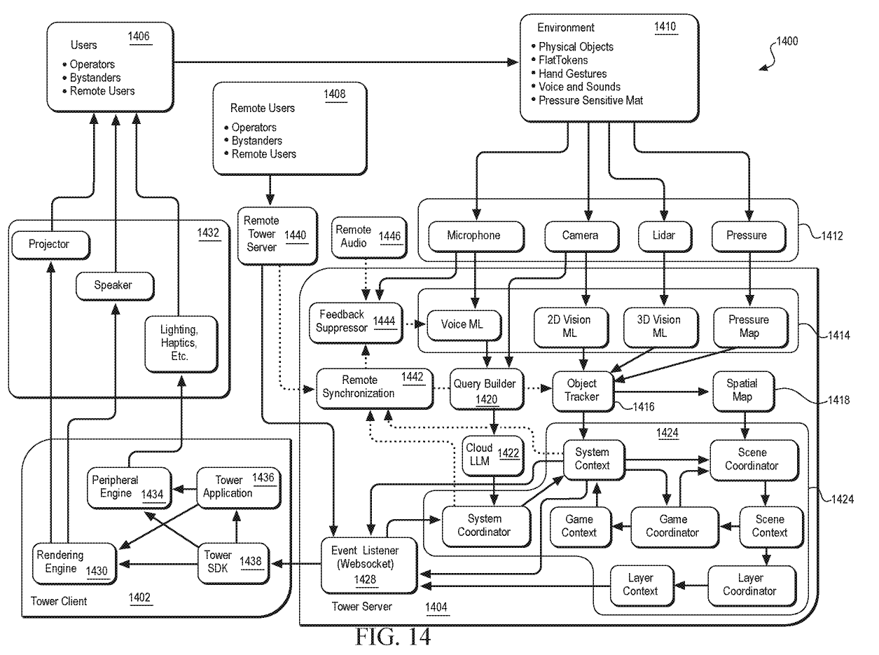

FIG. 11 illustrates a system software architecture diagram 1100 showing an embodiment of a high-level software organization in accordance with aspects of the present disclosure. As shown in FIG. 11, the software architecture includes hardware input/output peripherals including a microphone 1102, a camera 1104, and a projector 1106. An AI engine 1108 receives sensor data from the microphone 1102 and the camera 1104, processes the data using one or more machine learning pipelines, and generates raw events 1110 representing structured perceptual outputs such as detected objects, recognized vocal user inputs, and detected gestures. The raw events 1110 serve as the input interface between the sensing subsystem and the platform's core logic, such as described in further detail with respect to FIG. 12 (media events) and FIG. 14 (ML processing group).

In an embodiment, the software architecture separates system-level functions from application-level functions. A system core 1112 manages overall device operation, including device lifecycle, connectivity, user profiles, and peripheral management, and maintains a system state 1114. A game core 1116 (also referred to herein as an activity core or application logic core) manages activity-specific logic, including evaluation of activity-specific rules and tracking of the contextual state, and maintains a game state 1118. An app state 1128 maintains the state of a currently running application, which in some embodiments may include session data comprising a temporal sequence of previously obtained contextual states. The separation between system core 1112 and game core 1116 enables the platform to support diverse activities without requiring changes to the underlying system-level functions, and enables independent updating and extensibility of each layer.

A platform API 1120 (also referred to herein as Tower API) provides an interface between the cores (system core 1112 and game core 1116) and external applications. A platform application store 1122 (also referred to herein as tower application store) hosts first-party applications built with a platform SDK 1124 (also referred to herein as Tower SDK). A third-party application store 1126 hosts third-party applications also built with the platform SDK 1124. The platform SDK 1124 provides development tools, libraries, and interfaces by which developers may create applications that access the platform's sensing, projection, AI, and state-management capabilities via the platform API 1120. This extensible application ecosystem enables third-party developers to create new activities, games, instructional sequences, and other experiences for the platform without requiring modification of the system core 1112 or the AI engine 1108.

FIG. 12 illustrates a software processing architecture 1200 of the multimodal interactive platform, in accordance with aspects of the present disclosure. In an embodiment, the software processing architecture 1200 represents an example implementation of the computing system described herein, including software modules and data flows by which the platform receives multimodal input from the AIS, processes that input to obtain a contextual state, and generates response outputs including projected visual overlays and audio outputs. The software processing architecture 1200 provides additional detail on the data flow between aspects including the AI engine 1108, system core 1112, and game core 1116 described with respect to FIG. 11.

As shown in FIG. 12, the software processing architecture 1200 may include a video capture and detection module 1202, a voice command module 1204, a central event broker 1206, and a game engine module 1208. The video capture and detection module 1202 may be communicatively coupled to one or more image capture devices 1210 (e.g., one or more cameras of the sensing and projection assembly). The voice command module 1204 may be communicatively coupled to one or more audio capture devices 1212 (e.g., one or more microphones). The game engine module 1208 may be communicatively coupled to one or more projection devices 1214 (e.g., one or more projectors configured to display projected visual content onto the surface) and one or more audio output devices 1216 (e.g., one or more speakers).

In an embodiment, the one or more image capture devices 1210 may capture image data of the AIS, including physical objects disposed on or above the surface. Physical objects within the field of view of the one or more image capture devices 1210 may include, for example, game pieces, cards, tokens, instructional components, user hands or fingers, and other items relevant or irrelevant to the activity being performed. The video capture and detection module 1202 may include a video capture component 1218, an AI classification and bounding component 1220, and a detection filter component 1222. The video capture component 1218 may receive a stream of image data from the one or more image capture devices 1210 and may process individual frames or continuous video for downstream analysis. In some embodiments, the video capture component 1218 may be implemented using a computer vision library such as OpenCV or any other suitable image processing framework. The AI classification and bounding component 1220 may receive image data from the video capture component 1218 and may perform object detection, classification, and spatial bounding of physical objects within the AIS. In some embodiments, the AI classification and bounding component 1220 may be implemented using one or more machine learning frameworks such as TensorFlow, PyTorch, or any other suitable object detection library, and may employ techniques including but not limited to convolutional neural networks, region-based detection models, or single-shot detection architectures. The detection filter component 1222 may receive output from the AI classification and bounding component 1220 and may apply noise removal, temporal smoothing, or other filtering techniques to reduce false detections and stabilize object tracking over successive frames. The output of the detection filter component 1222 may be a set of detected objects 1224, which may include identification data, spatial positions, bounding regions, classification labels, and confidence scores associated with one or more physical objects within the AIS.

In an embodiment, the one or more audio capture devices 1212 may capture audio data from a vicinity of the surface and the AIS. Audio input received by the one or more audio capture devices 1212 may include relevant voice commands associated with the activity being performed, as well as irrelevant audio and ambient noise. The voice command module 1204 may include an audio capture script component 1226, a transcription component 1228, and a command parsing component 1230. The audio capture script component 1226 may receive a stream of audio data from the one or more audio capture devices 1212 and may perform initial audio processing such as buffering, noise gating, or voice activity detection. The transcription component 1228 may receive processed audio from the audio capture script component 1226 and may convert spoken-language audio into text. In some embodiments, the transcription component 1228 may be implemented using a speech-to-text model such as Whisper, or any other suitable automatic speech recognition system, and may operate locally on the computing system or via a remote service accessed through a network interface. In some embodiments, the audio data may be provided directly to a multimodal language model (e.g., a large language model capable of processing audio input) without a separate transcription step. The command parsing component 1230 may receive transcribed text from the transcription component 1228 and may apply natural language processing to extract a vocal user input, including an intent, a query, an instruction, or an action associated with the activity being performed within the AIS. The output of the command parsing component 1230 may be a parsed command 1232 representing the vocal user input.

In an embodiment, the central event broker 1206 may serve as a coordination layer between the sensing modules (e.g., the video capture and detection module 1202 and the voice command module 1204) and the game engine module 1208. The central event broker 1206 may include an event listener 1234, a graphics update logic component 1236, and an event sender 1238. The event listener 1234 may receive, as media events 1240, the detected objects 1224 from the video capture and detection module 1202 and the parsed commands 1232 from the voice command module 1204. The graphics update logic component 1236 may process the received media events 1240 to obtain a contextual state for the activity being performed within the AIS. In some embodiments, obtaining the contextual state may include evaluating one or more physical objects identified in the detected objects 1224 against a set of activity-specific rules, incorporating the vocal user input represented by the parsed commands 1232, and referencing session data including a temporal sequence of previously obtained contextual states. The graphics update logic component 1236 may further determine, based on the contextual state, one or more response outputs to be generated, including at least a projected visual overlay. The event sender 1238 may transmit the determined response outputs to the game engine module 1208. In some embodiments, the central event broker 1206 may be implemented as a lightweight server process, and may use networking protocols such as WebSockets, RESTful APIs (e.g., using FastAPI or a similar framework), or inter-process communication mechanisms to exchange data between modules.

In an embodiment, the game engine module 1208 may receive events from the central event broker 1206 and may generate and render the one or more response outputs. The game engine module 1208 may include an event listener 1242 and a game update component 1244. The event listener 1242 may receive events from the event sender 1238 of the central event broker 1206, for example via a WebSocket connection or other suitable communication channel. The game update component 1244 may generate audio and visual response outputs based on the received events. Visual response outputs, including projected visual overlays, may be rendered by the game update component 1244 and transmitted to the one or more projection devices 1214 for display within the AIS. Audio response outputs may be rendered by the game update component 1244 and transmitted to the one or more audio output devices 1216 for presentation in the vicinity of the AIS. In some embodiments, the game engine module 1208 may generate the projected visual overlay and the audio response output in a synchronized manner such that the audio response output corresponds temporally to the projected visual overlay displayed within the AIS. In some embodiments, the game engine module 1208 may be implemented using a game engine such as Godot, Unreal Engine, or any other suitable graphics engine or rendering framework. In other embodiments, the game engine module 1208 may be implemented using a Python-based graphics library or other custom rendering pipeline.

In some embodiments, one or more of the modules of the software processing architecture 1200 may execute locally on one or more processors of the computing system. In other embodiments, one or more of the modules may execute on a remote computing device, such as a cloud-based server, and may communicate with the computing system via a network interface. For example, the AI classification and bounding component 1220 may transmit image data or extracted features to a remote machine learning inference service and receive classification results via an API. Similarly, the transcription component 1228 or the command parsing component 1230 may transmit audio data or transcribed text to a remote large language model and receive parsed commands or contextual inferences in response. In some embodiments, one or more of the response outputs may include a generated visual asset obtained by transmitting a content generation request to a remote generative model and receiving the generated visual asset from the remote generative model.

FIG. 13 illustrates an application flow 1300 of the multimodal interactive platform, in accordance with aspects of the present disclosure. In an embodiment, the application flow 1300 represents an example startup and navigation sequence by which the computing system initializes the AIS, receives user input, and transitions through a series of interface states to launch an activity within the AIS. The application flow 1300 provides additional detail on how a user navigates from the homescreen through the activity category branches shown in FIG. 8 (user interface 800) and how the system core 1112 and game core 1116 described with respect to FIG. 11 are engaged during activity selection and initialization.

As shown in FIG. 13, the application flow 1300 may begin with a startup display 1302. In an embodiment, upon powering on the platform, the computing system may cause the one or more projection devices to display the startup display 1302 (e.g., an introductory video, animation, or branding sequence) within the AIS by projecting visual content onto the surface. Following the startup display 1302, the computing system may cause the one or more projection devices to display a homescreen 1304 within the AIS. The homescreen 1304 may present one or more activity categories or navigation options as projected visual content on the surface.

In an embodiment, upon displaying the homescreen 1304, the computing system may present an audio cue 1306 via the one or more audio output devices. The audio cue 1306 may include a spoken greeting, a prompt, or an indication that the platform is ready to receive user input. In some embodiments, the audio cue 1306 may include a spoken name or persona identifier (e.g., a configurable assistant name) associated with the platform, indicating that the platform is listening for vocal user input. The audio cue 1306 may serve as a wake indication, prompting a user to provide a vocal user input to navigate the homescreen 1304.

In an embodiment, from the homescreen 1304, the computing system may receive one or more vocal user inputs via the one or more audio capture devices. The computing system may process the received vocal user input to determine a selected activity category. The application flow 1300 may include a plurality of activity category branches including, for example, a first activity category branch 1308 (e.g., games), a second activity category branch 1310 (e.g., educational activities), and a third activity category branch 1312 (e.g., instructional activities). In some embodiments, one or more activity category branches may be associated with activities that are not yet available on the platform. In such cases, upon receiving a vocal user input corresponding to an unavailable activity category branch, the computing system may cause the one or more audio output devices and/or the one or more projection devices to present a notification response 1314 indicating that the selected category is not yet available (e.g., an audio response such as "That isn't ready yet" and/or a corresponding projected visual indicator). If the computing system does not recognize the vocal user input as corresponding to any activity category, the computing system may follow a fallback path 1316 (e.g., a "didn't understand" loop) and may prompt the user to repeat the vocal user input, for example by re-presenting the audio cue 1306 or by generating a projected visual overlay prompting the user to try again.

In an embodiment, upon receiving a vocal user input corresponding to an available activity category (e.g., the first activity category branch 1308), the computing system may transition to a scan screen state 1318. In the scan screen state 1318, the computing system may activate the one or more image capture devices and the one or more audio capture devices to capture image data and audio data of the AIS. In some embodiments, the scan screen state 1318 may include the computing system capturing image data to identify one or more physical objects disposed on or above the surface (e.g., game components, cards, or other items already placed within the AIS), and may use the identified objects to inform available activity selections. In some embodiments, the scan screen state 1318 may additionally or alternatively present a projected visual overlay prompting the user to place physical objects on the surface or to provide additional vocal user input to proceed.

In an embodiment, from the scan screen state 1318, the computing system may cause the one or more projection devices to display a selection interface 1320 within the AIS. The selection interface 1320 may present a plurality of selectable activity options as projected visual content on the surface. The plurality of selectable activity options may include, for example, a first activity option 1322, a second activity option 1324, and a third activity option 1326. Each activity option may correspond to a specific activity (e.g., a specific tabletop game, a specific guided instructional sequence, or another activity) that may be performed within the AIS. In some embodiments, the selection interface 1320 may alternatively or additionally be presented as a second homescreen displaying available activities within the selected activity category.

In an embodiment, from the selection interface 1320, the computing system may receive a vocal user input indicating a selected activity option. For example, the user may speak a name or identifier of a desired activity, and the computing system may process the vocal user input through the voice command module to determine which of the plurality of activity options was selected. Upon receiving a recognized vocal user input corresponding to a selectable activity option (e.g., the first activity option 1322, the second activity option 1324, or the third activity option 1326), the computing system may transition to an activity state associated with the selected activity option. In the activity state, the computing system may load a set of activity-specific rules, initialize session data, and begin obtaining a contextual state for the selected activity based on one or more physical objects within the AIS, as described elsewhere herein. If the computing system does not recognize the vocal user input as corresponding to any available activity option, the computing system may follow a respective fallback path 1328 and may prompt the user to repeat the vocal user input.

In some embodiments, the application flow 1300 may additionally or alternatively support navigation via image-based input rather than or in addition to vocal user input. For example, a user may place a physical object (e.g., a game box, a card, or a coded token) within the AIS, and the computing system may capture image data of the physical object, obtain identification data associated with the physical object, and transition to the corresponding activity state based on the identification data. In some embodiments, the application flow 1300 may additionally or alternatively support navigation via a companion application executing on a mobile computing device communicatively coupled to the computing system.

In some embodiments, the application flow 1300 may be configurable via user profiles. For example, when a user signs in to a user profile (e.g., via the companion application or via vocal user input), the computing system may adjust the homescreen 1304, the selection interface 1320, or the available activity options based on preferences, prior session data, or subscription status associated with the user profile.

FIG. 14 illustrates a detailed system architecture diagram 1400 showing the division between a client 1402 (also referred to herein as a Tower client or a platform client) and a server 1404 (also referred to herein as a Tower server or a platform server), and their interaction with users 1406, remote users 1408, and an environment 1410, in accordance with aspects of the present disclosure. The client 1402 and the server 1404 may execute on the same computing system (e.g., as separate processes or threads on the one or more processors of the sensing and projection assembly) or may execute on separate computing devices communicatively coupled via a network interface. The environment 1410 includes, for example, physical objects, flat tokens, hand gestures, voice and sounds, and in some embodiments a pressure-sensitive mat. Users 1406 may include operators (e.g., players, students, or instructors interacting within the AIS), bystanders, and remote users 1408 connected via a network.

A sensor array 1412 captures data from the environment 1410 and includes a microphone, a camera, a LiDAR sensor, and a pressure sensor. Each sensor within the sensor array 1412 feeds a corresponding machine learning pipeline within an ML processing group 1414. The ML processing group 1414 includes a Voice ML pipeline for processing audio data, a 2D Vision ML pipeline for processing two-dimensional image data, a 3D Vision ML pipeline for processing three-dimensional spatial data (e.g., from a depth sensing device or LiDAR sensor), and a Pressure Map processor for processing data from a pressure-sensitive mat. The ML processing group 1414 may produce structured perceptual data from raw sensor input, transforming unstructured sensor streams into classified, bounded, and semantically labeled outputs. In some embodiments, one or more pipelines within the ML processing group 1414 may execute locally on the computing system, while in other embodiments one or more pipelines may execute on a remote computing device via a network interface, as described herein with respect to FIG. 9.

An object tracker 1416 receives output from the 2D Vision ML and 3D Vision ML pipelines and maintains real-time tracking of physical objects and gestures within the environment 1410, including spatial positions, bounding regions, classification labels, and movement trajectories over successive frames. A spatial map 1418 receives LiDAR-derived 3D data and pressure map data to maintain a three-dimensional and pressure-aware spatial representation of the environment 1410, including the surface, physical objects disposed on or above the surface, and user positions relative to the AIS. The object tracker 1416 and the spatial map 1418 together provide the perceptual foundation from which the computing system derives contextual state — the object tracker 1416 providing object-level identity and position data, and the spatial map 1418 providing environment-level spatial data including depth, proximity, and surface contact information.

A query builder 1420 receives processed voice data from the Voice ML pipeline and object/context data from the object tracker 1416, and formulates structured queries combining the vocal user input with contextual information about the current state of the AIS. A cloud LLM 1422 receives queries from the query builder 1420 and returns natural language understanding results, rule interpretations, or generated responses. For example, when a user asks a question about a game rule, the query builder 1420 may construct a query that includes the transcribed vocal user input, identification data for the relevant physical objects, and the current contextual state, and the cloud LLM 1422 may return a spoken-language response and any associated contextual state updates. In some embodiments, the query builder 1420 may additionally or alternatively formulate content generation requests to a remote generative model, and the remote generative model may return generated visual assets for incorporation into the projected visual overlay.

A context and coordination hierarchy 1424 includes, at each respective level of abstraction, a context component and a corresponding coordinator component. At the system level, a system context maintains device-level state (e.g., connectivity, user profiles, peripheral status) and a system coordinator manages system-level logic and transitions. At the game level, a game context maintains activity-level state (e.g., the set of activity-specific rules, session data including the temporal sequence of previously obtained contextual states, game phase, player assignments, and score data) and a game coordinator manages activity-level logic including rules evaluation and response determination. At the scene level, a scene context maintains the current visual and spatial scene configuration and a scene coordinator manages scene transitions and rendering updates. At the layer level, a layer context maintains state for individual interaction layers—including the physical object layer and the projected content layer described herein with respect to FIG. 10—and a layer coordinator manages updates to those layers. The system coordinator receives input from the cloud LLM 1422 and the context and coordination hierarchy 1424, and orchestrates high-level system behavior. Higher-level components (system, game) govern lower-level components (scene, layer), enabling a cascading state-management architecture in which, for example, a change in game context (e.g., a new game phase) propagates downward to update the visual scene and individual interaction layers accordingly. The context and coordination hierarchy 1424 represents an embodiment of an architectural implementation of the contextual state evaluation and response generation described throughout this specification.

An event listener 1428 (e.g., websocket-based) bridges the server 1404 to the client 1402, distributing events and state updates in real time. The client 1402 includes a rendering engine 1430 that generates visual output based on received events and drives output peripherals 1432 including a projector, a speaker, and lighting and haptic devices. A peripheral engine 1434 manages communication with the output peripherals 1432. A platform application 1436 (also referred to herein as a Tower application) represents a running application instance on the client 1402, and a platform SDK 1438 (also referred to herein as a Tower SDK) provides the development interface through which the platform application 1436 communicates with the server 1404 via the event listener 1428. The separation of the client 1402 and the server 1404 enables the rendering and output functions to operate at display-refresh rates while the ML processing, contextual state evaluation, and coordination functions operate asynchronously on the server.

A remote server 1440 (also referred to herein as a remote Tower server) enables communication with remote users 1408 over a network. Remote synchronization 1442 manages state synchronization between the local server 1404 and the remote server 1440, enabling the shared-activity networked operation described herein with respect to FIG. 10, including bidirectional transmission of contextual data and position-mapped remote physical object projection. A feedback suppressor 1444 processes remote audio 1446 received from the remote server 1440 to prevent audio feedback loops between the microphone within the sensor array 1412 and the speaker within the output peripherals 1432. The feedback suppressor 1444 ensures clean voice capture for local Voice ML processing while remote audio is being played through the output peripherals 1432, thereby maintaining the accuracy of vocal user input recognition during networked sessions. In some embodiments, the feedback suppressor 1444 may implement acoustic echo cancellation, spectral subtraction, or other suitable audio processing techniques.

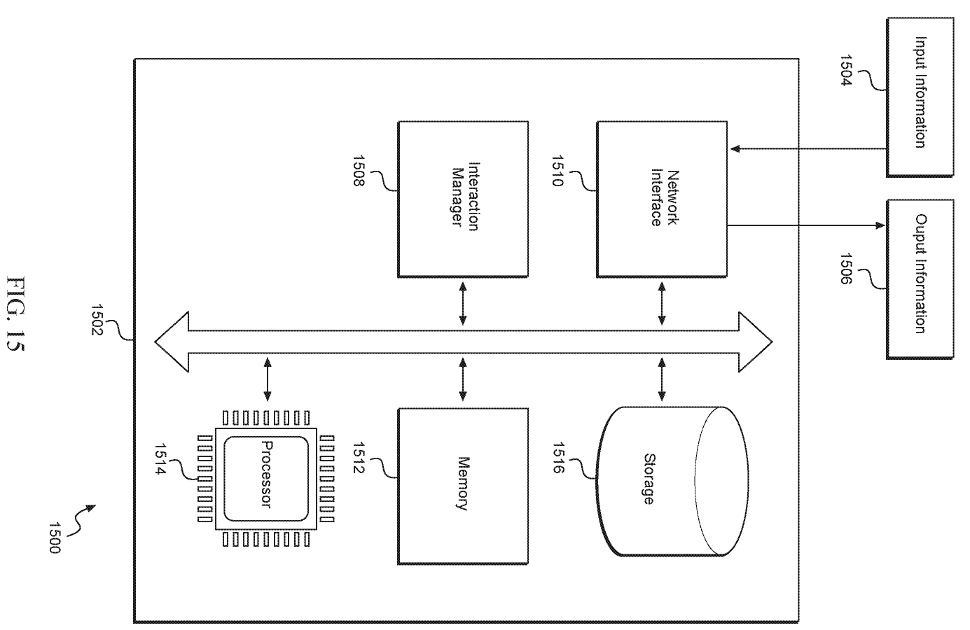

FIG. 15 shows a diagram of a system 1500 including a device 1502 that supports providing contextual feedback within an augmented interaction space in accordance with aspects of the present disclosure. The device 1502 may be an example of or include components of a computing system 310 as described herein with respect to FIG. 3, a computing system 920 as described herein with respect to FIG. 9, or any other computing system described herein. The device 1502 may include components for bi-directional voice and data communications including components for transmitting and receiving communications, such as an interaction manager 1508, input information 1504, output information 1506, a network interface 1510, at least one memory 1512, at least one processor 1514, and a storage 1516. These components may be in electronic communication or otherwise coupled (e.g., operatively, communicatively, functionally, electronically, electrically) via one or more buses (e.g., communication links, communication interfaces, or any combination thereof).

The network interface 1510 may enable the device 1502 to exchange information (e.g., input information 1504, output information 1506, or both) with other systems or devices (not shown). For example, the network interface 1510 may enable the device 1502 to connect to a network (e.g., a cloud 902 as described herein with respect to FIG. 9, a remote server 1440 as described herein with respect to FIG. 14, or any other network). The network interface 1510 may include one or more wireless network interfaces, one or more wired network interfaces, or any combination thereof.

Memory 1512 may include RAM, ROM, or both. The memory 1512 may store computer-readable, computer-executable software including instructions that, when executed, cause at least one processor 1514 to perform various functions described herein, such as functions supporting providing contextual feedback within an augmented interaction space. In some cases, the memory 1512 may contain, among other things, a basic input/output system (BIOS), which may control basic hardware or software operation such as the interaction with peripheral components or devices. In some cases, the memory 1512 may be an example of aspects of one or more components of a sensing and projection assembly as described herein with reference to FIG. 1. The memory 1512 may be an example of a single memory or multiple memories. For example, the device 1502 may include one or more memories 1512.

The processor 1514 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1514 may be configured to execute computer-readable instructions stored in at least one memory 1512 to perform various functions (e.g., functions or tasks supporting providing contextual feedback within an augmented interaction space). Though a single processor 1514 is depicted in the example of FIG. 15, it is to be understood that the device 1502 may include any quantity of one or more of processors 1514 and that a group of processors 1514 may collectively perform one or more functions ascribed herein to a processor, such as the processor 1514. The processor 1514 may be an example of a single processor or multiple processors. For example, the device 1502 may include one or more processors 1514.

Storage 1516 may be configured to store data that is generated, processed, stored, or otherwise used by the device 1502. In some cases, the storage 1516 may include one or more HDDs, one or more SSDs, or both. In some examples, the storage 1516 may be an example of a single database, a distributed database, multiple distributed databases, a data store, a data lake, or an emergency backup database. In some examples, the storage 1516 may store activity-specific rules, session data including a temporal sequence of previously obtained contextual states, identification data associated with physical objects, user profiles, or application data as described herein.

For example, the interaction manager 1508 may be configured as or otherwise support a means for receiving image data from one or more image capture devices of a sensing and projection assembly, the one or more image capture devices oriented to capture image data of a surface and a region above the surface within an augmented interaction space. The interaction manager 1508 may be configured as or otherwise support a means for obtaining, based on at least the image data, a contextual state for an activity being performed within the augmented interaction space, the contextual state based at least in part on one or more physical objects within the augmented interaction space. The interaction manager 1508 may be configured as or otherwise support a means for obtaining, based on at least the image data, identification data associated with the one or more physical objects within the augmented interaction space, wherein the contextual state is based at least in part on the identification data. The interaction manager 1508 may be configured as or otherwise support a means for obtaining the contextual state by evaluating the one or more physical objects within the augmented interaction space against a set of activity-specific rules. The interaction manager 1508 may be configured as or otherwise support a means for obtaining, based on the contextual state, one or more response outputs including at least a projected visual overlay. The interaction manager 1508 may be configured as or otherwise support a means for causing one or more projection devices of the sensing and projection assembly to display the projected visual overlay within the augmented interaction space. The interaction manager 1508 may be configured as or otherwise support a means for obtaining the contextual state based at least in part on session data stored in the memory 1512 or the storage 1516, the session data including a temporal sequence of previously obtained contextual states for the activity.

By including or configuring the interaction manager 1508 in accordance with examples as described herein, the device 1502 may support techniques for improved real-time contextual feedback within an augmented interaction space, reduced latency in response output generation, improved user experience through activity-specific rule enforcement and session-aware state tracking, and improved coordination between sensing, processing, and projection components, among other examples.

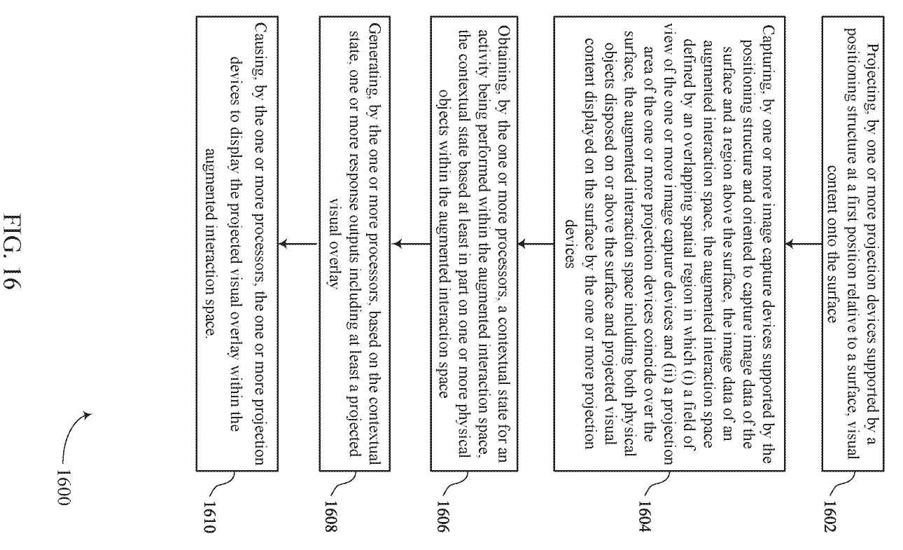

FIG. 16 shows a flowchart illustrating a method 1600 for providing multimodal interactive feedback within an augmented interaction space in accordance with aspects of the present disclosure. The operations of the method 1600 may be implemented by the multimodal interactive platform or its components as described herein. For example, the operations of the method 1600 may be performed by a sensing and projection assembly and a computing system as described with reference to FIGS. 1 through 14. In some examples, the computing system may execute a set of instructions to control the functional elements of the multimodal interactive platform to perform the described functions. Additionally, or alternatively, the multimodal interactive platform may perform aspects of the described functions using special-purpose hardware.

At 1602, the method may include projecting, by one or more projection devices supported by a positioning structure at a first position relative to a surface, visual content onto the surface. The operations of 1602 may be performed in accordance with examples as disclosed herein. In some examples, aspects of the operations of 1602 may be performed by a rendering engine 1430 and one or more projection devices within the output peripherals 1432 as described with reference to FIG. 14, or by a game engine module 1208 and one or more projection devices 1214 as described with reference to FIG. 12.

At 1604, the method may include capturing, by one or more image capture devices supported by the positioning structure and oriented to capture image data of the surface and a region above the surface, the image data of an augmented interaction space, the augmented interaction space defined by an overlapping spatial region in which (i) a field of view of the one or more image capture devices and (ii) a projection area of the one or more projection devices coincide over the surface, the augmented interaction space including both physical objects disposed on or above the surface and projected visual content displayed on the surface by the one or more projection devices. The operations of 1604 may be performed in accordance with examples as disclosed herein. In some examples, aspects of the operations of 1604 may be performed by a sensor array 1412 and an ML processing group 1414 as described with reference to FIG. 14, or by a video capture and detection module 1202 and one or more image capture devices 1210 as described with reference to FIG. 12.

At 1606, the method may include obtaining, by one or more processors, a contextual state for an activity being performed within the augmented interaction space, the contextual state based at least in part on one or more physical objects within the augmented interaction space. The operations of 1606 may be performed in accordance with examples as disclosed herein. In some examples, aspects of the operations of 1606 may be performed by a context and coordination hierarchy 1424 as described with reference to FIG. 14, or by a graphics update logic component 1236 of a central event broker 1206 as described with reference to FIG. 12.

At 1608, the method may include generating, by the one or more processors, based on the contextual state, one or more response outputs including at least a projected visual overlay. The operations of 1608 may be performed in accordance with examples as disclosed herein. In some examples, aspects of the operations of 1608 may be performed by the context and coordination hierarchy 1424 and an event listener 1428 as described with reference to FIG. 14, or by the graphics update logic component 1236 and an event sender 1238 of the central event broker 1206 as described with reference to FIG. 12.

At 1610, the method may include causing, by the one or more processors, the one or more projection devices to display the projected visual overlay within the augmented interaction space. The operations of 1610 may be performed in accordance with examples as disclosed herein. In some examples, aspects of the operations of 1610 may be performed by the rendering engine 1430 and the output peripherals 1432 as described with reference to FIG. 14, or by the game engine module 1208 and the one or more projection devices 1214 as described with reference to FIG. 12.

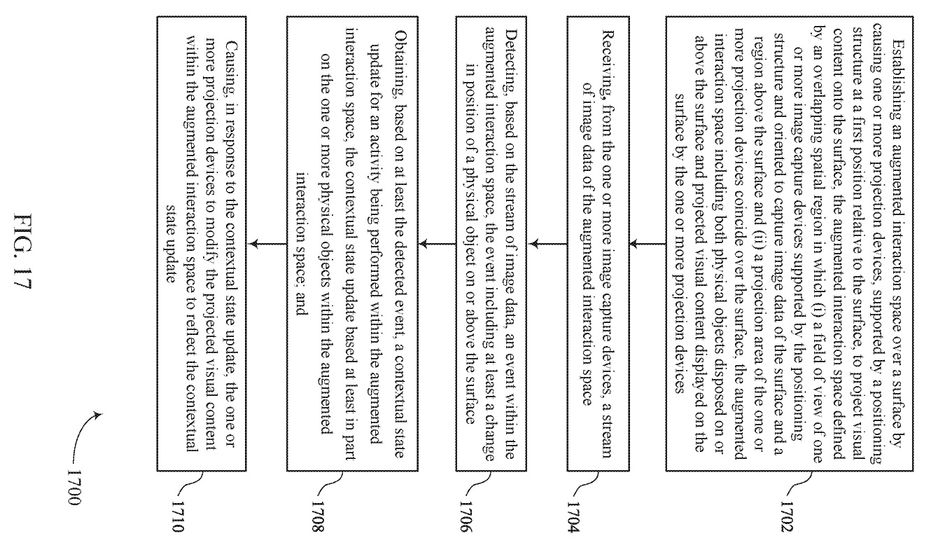

FIG. 17 shows a flowchart illustrating a method 1700 for providing contextual feedback within an augmented interaction space in accordance with aspects of the present disclosure. The operations of the method 1700 may be implemented by the multimodal interactive platform or its components as described herein. For example, the operations of the method 1700 may be performed by a computing system as described with reference to FIGS. 1 through 15. In some examples, the computing system may execute a set of instructions to control the functional elements of the multimodal interactive platform to perform the described functions. Additionally, or alternatively, the multimodal interactive platform may perform aspects of the described functions using special-purpose hardware.

At 1702, the method may include establishing an augmented interaction space over a surface by causing one or more projection devices, supported by a positioning structure at a first position relative to the surface, to project visual content onto the surface, the augmented interaction space defined by an overlapping spatial region in which (i) a field of view of one or more image capture devices supported by the positioning structure and oriented to capture image data of the surface and a region above the surface and (ii) a projection area of the one or more projection devices coincide over the surface, the augmented interaction space including both physical objects disposed on or above the surface and projected visual content displayed on the surface by the one or more projection devices. The operations of 1702 may be performed in accordance with examples as disclosed herein. In some examples, aspects of the operations of 1702 may be performed by a rendering engine 1430 and output peripherals 1432 as described with reference to FIG. 14, or by a game engine module 1208 and one or more projection devices 1214 as described with reference to FIG. 12.

At 1704, the method may include receiving, from the one or more image capture devices, a stream of image data of the augmented interaction space. The operations of 1704 may be performed in accordance with examples as disclosed herein. In some examples, aspects of the operations of 1704 may be performed by a sensor array 1412 and an ML processing group 1414 as described with reference to FIG. 14, or by a video capture component 1218 of a video capture and detection module 1202 as described with reference to FIG. 12.

At 1706, the method may include detecting, based on the stream of image data, an event within the augmented interaction space, the event including at least a change in position of a physical object on or above the surface. The operations of 1706 may be performed in accordance with examples as disclosed herein. In some examples, aspects of the operations of 1706 may be performed by an object tracker 1416 as described with reference to FIG. 14, or by an AI classification and bounding component 1220 and a detection filter component 1222 of the video capture and detection module 1202 as described with reference to FIG. 12.

At 1708, the method may include obtaining, based on at least the detected event, a contextual state update for an activity being performed within the augmented interaction space, the contextual state update based at least in part on the one or more physical objects within the augmented interaction space. The operations of 1708 may be performed in accordance with examples as disclosed herein. In some examples, aspects of the operations of 1708 may be performed by a context and coordination hierarchy 1424 as described with reference to FIG. 14, or by a graphics update logic component 1236 of a central event broker 1206 as described with reference to FIG. 12.

At 1710, the method may include causing, in response to the contextual state update, the one or more projection devices to modify the projected visual content within the augmented interaction space to reflect the contextual state update. The operations of 1710 may be performed in accordance with examples as disclosed herein. In some examples, aspects of the operations of 1710 may be performed by the rendering engine 1430 and the output peripherals 1432 as described with reference to FIG. 14, or by a game update component 1244 of the game engine module 1208 and one or more projection devices 1214 as described with reference to FIG. 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A multimodal interactive platform, comprising:
a sensing and projection assembly, including:
a positioning structure configured to support one or more electronic components at a first position relative to a surface,
one or more image capture devices supported by the positioning structure and oriented to capture image data of the surface and a region above the surface, and
one or more projection devices supported by the positioning structure and configured to project visual content onto the surface;
an augmented interaction space defined by an overlapping spatial region in which (i) a field of view of the one or more image capture devices and (ii) a projection area of the one or more projection devices coincide over the surface, the augmented interaction space including both physical objects disposed on or above the surface and projected visual content displayed on the surface by the one or more projection devices; and
a computing system including one or more processors and one or more memories coupled to the one or more processors, the one or more memories storing instructions that, when executed by the one or more processors, cause the computing system to:
receive the image data from the sensing and projection assembly,
obtain, based on at least the image data, a contextual state for an activity being performed within the augmented interaction space, the contextual state based at least in part on one or more physical objects within the augmented interaction space,
obtain, based on the contextual state, one or more response outputs including at least a projected visual overlay, and
cause the one or more projection devices to display the projected visual overlay within the augmented interaction space.

2. The platform of claim 1, wherein the instructions further cause the computing system to:
obtain, based on at least the image data, identification data associated with the one or more physical objects within the augmented interaction space, wherein the contextual state is based at least in part on the identification data.

3. The platform of claim 1, the sensing and projection assembly further comprising one or more audio capture devices configured to capture audio data from a vicinity of the surface, and the instructions further causing the computing system to:
receive the audio data from the sensing and projection assembly, and
obtain, based on at least the audio data, a vocal user input associated with the activity being performed within the augmented interaction space,
wherein the contextual state is further based on the vocal user input.

4. The platform of claim 3, further comprising one or more audio output devices supported by the positioning structure and the instructions further cause the computing system to:
obtain, based on the contextual state, an audio response output, and
cause the one or more audio output devices to present the audio response output.

5. The platform of claim 4, wherein the audio response output comprises a spoken-language response corresponding to the vocal user input.

6. The platform of claim 4, wherein the instructions further cause the computing system to:
generate the projected visual overlay and the audio response output in a synchronized manner such that the audio response output corresponds temporally to the projected visual overlay displayed within the augmented interaction space.

7. The platform of claim 1, the one or more image capture devices including at least one depth sensing device configured to capture three-dimensional spatial data of the augmented interaction space, and wherein the contextual state is based at least in part on the three-dimensional spatial data.

8. The platform of claim 7, wherein the at least one depth sensing device comprises at least one of a time-of-flight sensor, a structured light sensor, or a stereo depth camera.

9. The platform of claim 7, wherein the instructions further cause the computing system to determine, based on the three-dimensional spatial data, at least one of: a height, a volume, or a contour of one or more physical objects within the augmented interaction space.

10. The platform of claim 1, wherein the sensing and projection assembly further comprises at least one LiDAR sensor configured to capture spatial data of the augmented interaction space and a region adjacent to the augmented interaction space.

11. The platform of claim 10, wherein the instructions further cause the computing system to:
detect, based on spatial data from the at least one LiDAR sensor, one or more user gestures performed on, above, or adjacent to the surface, and wherein the contextual state is further based on the one or more detected user gestures.

12. The platform of claim 10, wherein the instructions further cause the computing system to:
determine, based on spatial data from the at least one LiDAR sensor, a posture or a proxemic position of one or more users relative to the augmented interaction space.

13. The platform of claim 1, wherein the instructions further cause the computing system to obtain the contextual state by evaluating one or more physical objects within the augmented interaction space against a set of activity-specific rules.

14. The platform of claim 13, wherein the set of activity-specific rules comprises game rules for a tabletop game, and wherein the contextual state comprises at least one of: a current game phase, a current active player, a game score, or a resource pool associated with a player.

15. The platform of claim 14, wherein the instructions further cause the computing system to:
detect, based on the contextual state, an impermissible game action; and
generate a corrective visual indicator as part of the projected visual overlay.

16. The platform of claim 1, wherein the one or more memories further store session data including a temporal sequence of previously obtained contextual states for the activity, and wherein the instructions cause the computing system to obtain the contextual state based at least in part on the session data.

17. The platform of claim 16, wherein the session data includes at least one of: a history of physical object placements within the augmented interaction space, a history of user inputs, or a history of previously generated response outputs.

18. The platform of claim 1, further comprising a companion application executing on a mobile computing device communicatively coupled to the computing system, the companion application configured to provide at least one of: user profile management, activity library selection, system configuration, or performance analytics display.

19. A method for providing multimodal interactive feedback within an augmented interaction space, the method comprising:
projecting, by one or more projection devices supported by a positioning structure at a first position relative to a surface, visual content onto the surface;
capturing, by one or more image capture devices supported by the positioning structure and oriented to capture image data of the surface and a region above the surface, the image data of an augmented interaction space, the augmented interaction space defined by an overlapping spatial region in which (i) a field of view of the one or more image capture devices and (ii) a projection area of the one or more projection devices coincide over the surface, the augmented interaction space including both physical objects disposed on or above the surface and projected visual content displayed on the surface by the one or more projection devices;
obtaining, by one or more processors, a contextual state for an activity being performed within the augmented interaction space, the contextual state based at least in part on one or more physical objects within the augmented interaction space;
generating, by the one or more processors, based on the contextual state, one or more response outputs including at least a projected visual overlay; and
causing, by the one or more processors, the one or more projection devices to display the projected visual overlay within the augmented interaction space.

20. A computing system for providing contextual feedback within an augmented interaction space, comprising:
one or more processors; and
one or more memories coupled to the one or more processors, the one or more memories storing instructions that, when executed by the one or more processors, cause the computing system to:
establish an augmented interaction space over a surface by causing one or more projection devices, supported by a positioning structure at a first position relative to the surface, to project visual content onto the surface, the augmented interaction space defined by an overlapping spatial region in which (i) a field of view of one or more image capture devices supported by the positioning structure and oriented to capture image data of the surface and a region above the surface and (ii) a projection area of the one or more projection devices coincide over the surface, the augmented interaction space including both physical objects disposed on or above the surface and projected visual content displayed on the surface by the one or more projection devices;
receive, from the one or more image capture devices, a stream of image data of the augmented interaction space;
detect, based on the stream of image data, an event within the augmented interaction space, the event including at least a change in position of a physical object on or above the surface;
obtain, based on at least the detected event, a contextual state update for an activity being performed within the augmented interaction space, the contextual state update based at least in part on the one or more physical objects within the augmented interaction space; and
cause, in response to the contextual state update, the one or more projection devices to modify the projected visual content within the augmented interaction space to reflect the contextual state update.
